(19) United States
(12) Patent Application Publication
(10) Pub. No.: US 2017/0205611 A1
(43) Pub. Date: Jul. 20, 2017

(54) IMAGING OPTICAL SYSTEM, ILLUMINATING DEVICE, AND MICROSCOPE APPARATUS

(71) Applicant: OLYMPUS CORPORATION, Tokyo (JP)

(72) Inventor: Hiroya FUKUYAMA, Tokyo (JP)

(73) Assignee: OLYMPUS CORPORATION, Tokyo (JP)

(21) Appl. No.: 15/476,086

(22) Filed: Mar. 31, 2017

Related U.S. Application Data
(63) Continuation of application No. PCT/JP2015/078760, filed on Oct. 9, 2015.

(30) Foreign Application Priority Data
Oct. 9, 2014 (JP) 2014-208114

(51) Int. Cl. G02B 21/00

(52) U.S. Cl. CPC G02B 21/008; G02B 21/0032; G02B 21/006; G02B 21/0076

(57) ABSTRACT

Provided is an imaging optical system including: a plurality of imaging lenses that form a final image and at least one intermediate image; a first phase modulation element that is disposed closer to an object than any of the at least one intermediate image is and that gives a spatial disturbance to the wavefront of light from the object; and a second phase modulation element that is disposed at a position so as to sandwich the at least one intermediate image with the first phase modulation element and that cancels out the spatial disturbance given to the wavefront of the light from the object by the first phase modulation element. The imaging lenses are configured so as to satisfy Herschel's condition.

### CROSS-REFERENCE TO RELATED APPLICATIONS

This is a continuation of International Application PCT/JP2015/078760 which is hereby incorporated by reference herein in its entirety.

This application is based on Japanese Patent Application No. 2014-208114, the contents of which are incorporated herein by reference.

### TECHNICAL FIELD

The present invention relates to an imaging optical system, an illuminating device, and a microscope apparatus.

### BACKGROUND ART

There is a conventionally known method in which the optical-path length is adjusted at the position of an intermediate image, thereby moving the focal position in an object in the direction along the optical axis (on the Z axis) (for example, see PTL 1 and PTL 2).

### CITATION LIST

### Patent Literature

{PTL 1} Publication of Japanese Patent No. 4011704
{PTL 2} Japanese Translation of PCT International Application, Publication No. 2010-513968

### SUMMARY OF INVENTION

According to one aspect, the present invention provides an imaging optical system including: a plurality of imaging lenses that form a final image and at least one intermediate image; a first phase modulation element that is disposed closer to an object than any of the at least one intermediate image formed by the imaging lenses is and that gives a spatial disturbance to the wavefront of light from the object; and a second phase modulation element that is disposed at a position so as to sandwich the at least one intermediate image with the first phase modulation element and that cancels out the spatial disturbance given to the wavefront of the light from the object by the first phase modulation element, wherein the imaging lenses are configured so as to satisfy Herschel's condition.

### BRIEF DESCRIPTION OF DRAWINGS

FIG. 1 is a schematic view showing one embodiment of an imaging optical system to be used in a microscope apparatus of the present invention.

FIG. 2 is a schematic view for explaining the operation of the imaging optical system shown in FIG. 1.

FIG. 3 is an enlarged view showing the range from an object-side pupil position to a wavefront restoring element shown in FIG. 2.

FIG. 4 is a schematic view showing an imaging optical system to be used in a conventional microscope apparatus.

FIG. 5 is a view showing a state in which imaging lenses having a long focal length are disposed in a pair in the light path.

FIG. 6 is a view showing a state in which imaging lenses having a short focal length are disposed in a pair in the light path.

FIG. 7 is a view showing an example imaging optical system according to a first modification of the one embodiment of the present invention.

FIG. 8 is a view showing an example imaging optical system according to a second modification of the one embodiment of the present invention.

FIG. 9 is a schematic view showing an observation device according to a first reference embodiment of the present invention.

FIG. 10 is a schematic view showing an observation device according to a first embodiment of the present invention.

FIG. 11 is a schematic view showing a state in which, in the observation device shown in FIG. 10, an objective lens that has a short focal length and high magnification and a relay lens that has a short focal length and a large NA are disposed in the light path.

FIG. 12 is a schematic view showing an observation device according to a second reference embodiment of the present invention.

FIG. 13 is a schematic view showing an observation device according to a third reference embodiment of the present invention.

FIG. 14 is a schematic view showing a modification of the observation device shown in FIG. 13.

FIG. 15 is a schematic view showing a first modification of the observation device shown in FIG. 14.

FIG. 16 is a schematic view showing another modification of the observation device shown in FIG. 14.

FIG. 17 is a schematic view showing a second modification of the observation device shown in FIG. 14.

FIG. 18 is a schematic view showing a third modification of the observation device shown in FIG. 14.

FIG. 19 is a schematic view showing an observation device according to a second embodiment of the present invention.

FIG. 20 is a schematic view showing a state in which, in the observation device shown in FIG. 19, a second lens that has a short focal length and a collimator lens that has a long focal length are disposed in the light path.

FIG. 21 is a schematic view showing a state in which, in the observation device shown in FIG. 19, a second lens that has a long focal length and a collimator lens that has a short focal length are disposed in the light path.

FIG. 22 is a schematic view showing an illumination optical system of an observation device according to a first modification of the second embodiment of the present invention.

FIG. 23 is a schematic view showing an illumination optical system of an observation device according to a second modification of the second embodiment of the present invention.

FIG. 24 is a perspective view showing cylindrical lenses serving as examples phase modulation elements used in the imaging optical systems and the observation devices according to the present invention.

FIG. 25 is a schematic view for explaining the operation when the cylindrical lenses shown in FIG. 24 are used.

FIG. 26 is a view for explaining the relationship between the phase modulation amount and the optical power based on Gaussian optics, used to explain FIG. 25.

FIG. 27 is a perspective view showing binary diffraction gratings as other examples of the phase modulation elements used in the imaging optical systems and the observation devices according to the present invention.

FIG. 28 is a perspective view showing one-dimensional sinusoidal diffraction gratings as other examples of the phase modulation elements used in the imaging optical systems and the observation devices according to the present invention.

FIG. 29 is a perspective view showing free-form surface lenses as other examples of the phase modulation elements used in the imaging optical systems and the observation devices according to the present invention.

FIG. 30 is a longitudinal sectional view showing cone lenses as other examples of the phase modulation elements used in the imaging optical systems and the observation devices according to the present invention.

FIG. 31 is a perspective view showing concentric binary diffraction gratings as other examples of the phase modulation elements used in the imaging optical systems and the observation devices according to the present invention.

FIG. 32 is a schematic view for explaining the operation of a light ray along the optical axis when diffraction gratings are used as the phase modulation elements.

FIG. 33 is a schematic view for explaining the operation of an on-axis light ray when the diffraction gratings are used as the phase modulation elements.

FIG. 34 is a central-area detailed view for explaining the operation of the diffraction grating that functions as a wavefront disturbing element.

FIG. 35 is a central-area detailed view for explaining the operation of the diffraction grating that functions as a wavefront restoring element.

FIG. 36 is a longitudinal sectional view showing spherical aberration elements as other examples of the phase modulation elements used in the imaging optical systems and the observation devices according to the present invention.

FIG. 37 is a longitudinal sectional view showing irregular-shaped elements as other examples of the phase modulation elements used in the imaging optical systems and the observation devices according to the present invention.

FIG. 38 is a schematic view showing a reflective phase modulation element as another example of the phase modulation element used in the imaging optical systems and the observation devices according to the present invention.

FIG. 39 is a schematic view showing refractive-index distribution elements as other examples of the phase modulation elements used in the imaging optical systems and the observation devices according to the present invention.

FIG. 40 is a view showing an example lens array when the imaging optical systems according to the present invention are applied to a device used for microscopic magnified observation for an endoscopic purpose.

FIG. 41 is a view showing an example lens array when the imaging optical systems according to the present invention are applied to a microscope that is provided with an endoscope-type small-diameter objective lens having an inner focus function.

FIG. 42 is a schematic view showing an observation device according to one embodiment of the present invention.

FIG. 43 is a plan view showing an illuminating device shown in FIG. 42.

FIG. 44 is a side view showing the illuminating device shown in FIG. 42.

FIG. 45 is a transverse sectional view showing passing positions on a wavefront restoring element shown in FIG. 42 at which a light flux is made to pass therethrough by a scanning operation.

FIG. 46 is a transverse sectional view showing passing positions on the pupil position of an objective lens shown in FIG. 42, at which a light flux is made to pass therethrough by a scanning operation.

FIG. 47 is an enlarged schematic view showing part of an illuminating device according to one Example of the present invention.

### DESCRIPTION OF EMBODIMENTS

One embodiment of an imaging optical system 1 to be used in a microscope apparatus of the present invention will be described below with reference to the drawings.

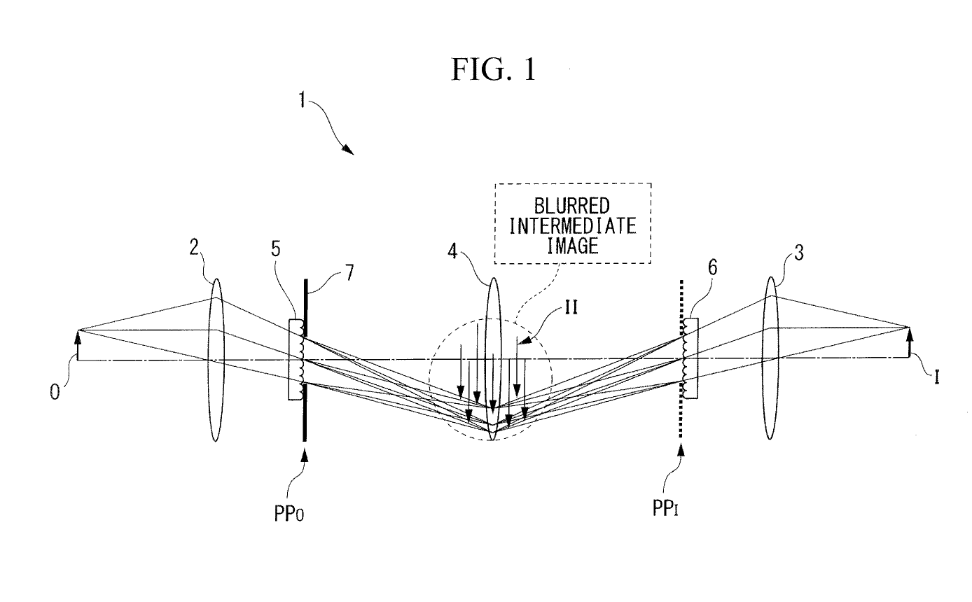

As shown in FIG. 1, the imaging optical system 1 of this embodiment is provided with: two imaging lenses 2 and 3 constituting a pair and that are provided with a space therebetween; a field lens 4 that is disposed in an intermediate image plane between the imaging lenses 2 and 3; a wavefront disturbing element (first phase modulation element) 5 that is disposed in the vicinity of a pupil position PP_{O} of the imaging lens 2, which is close to an object O; and a wavefront restoring element (second phase modulation element) 6 that is disposed in the vicinity of a pupil position PP_{I} of the imaging lens 3, which is close to an image I. In the figure, reference sign 7 denotes an aperture stop.

The wavefront disturbing element 5 gives a disturbance to the wavefront of light produced in the object O and focused by the imaging lens 2, which is close to the object O, when the light is transmitted through the wavefront disturbing element 5. The wavefront disturbing element 5 gives a disturbance to the wavefront, thereby blurring an intermediate image formed in the field lens 4.

On the other hand, the wavefront restoring element 6 applies, to the light focused by the field lens 4 when transmitted through the wavefront restoring element 6, a phase modulation that cancels out the wavefront disturbance given by the wavefront disturbing element 5. The wavefront restoring element 6 has reverse phase characteristics from the wavefront disturbing element 5 and cancels out the wavefront disturbance, thereby allowing a clear final image I to be formed.

A more general concept of the imaging optical system 1 of this embodiment will be described in detail.

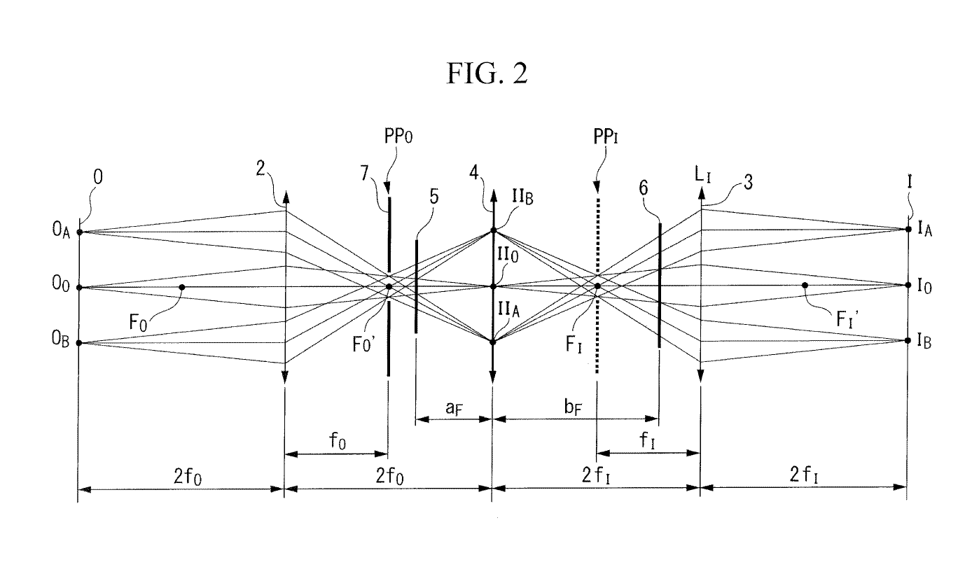

In the example shown in FIG. 2, the imaging optical system 1 has a telecentric arrangement on the object O side and the image I side. Furthermore, the wavefront disturbing element 5 is disposed at a position away from the field lens 4 toward the object O by a distance a_{F}, and the wavefront restoring element 6 is disposed at a position away from the field lens 4 toward the image I by a distance b_{F}.

In FIG. 2, reference sign f_{O} is the focal length of the imaging lens 2, reference sign f_{I} is the focal length of the imaging lens 3, reference signs F_{O} and F_{O}′ are focal positions of the imaging lens 2, reference signs F_{I} and F_{I}′ are focal positions of the imaging lens 3, and reference signs II_{O}, II_{A}, and II_{B} are intermediate images.

Here, the wavefront disturbing element 5 does not necessarily need to be disposed in the vicinity of the pupil position PP_{O} of the imaging lens 2, and the wavefront restoring element 6 does not necessarily need to be disposed in the vicinity of the pupil position PP_{I} of the imaging lens 3.

However, the wavefront disturbing element 5 and the wavefront restoring element 6 need to be disposed so as to have a conjugate positional relation with each other, regarding image formation at the field lens 4, as shown in Expression (1).

1/f_{F}=1/a_{F}+1/b_{F} (1)

where f_{F} is the focal length of the field lens 4.

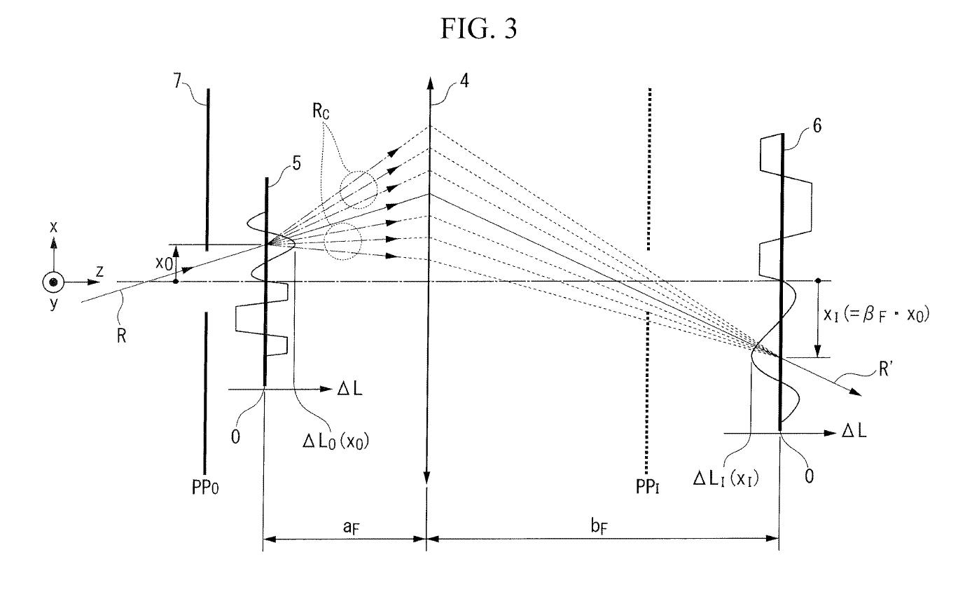

FIG. 3 is a view showing, in detail, the range from the pupil position PP_{O} on the object O side to the wavefront restoring element 6, shown in FIG. 2.

Here, ΔL is a phase lead that is given to light when transmitted through an optical element and that is based on a light ray transmitted through a particular position (i.e., ray height).

Furthermore, ΔL_{O}(x_{O}) is a function for giving a phase lead when light is transmitted through the wavefront disturbing element 5 at a desired ray height x_{O}, with reference to the case in which light is transmitted through the wavefront disturbing element 5 at the optical axis (x=0).

Furthermore, ΔL_{I}(x_{I}) is a function for giving a phase lead when light is transmitted through the wavefront restoring element 6 at a desired ray height xᵢ, with reference to the case in which light is transmitted through the wavefront restoring element 6 at the optical axis (x=0).

ΔL_{O}(x_{O}) and ΔL_{I}(x_{I}) satisfy Expression (2).

ΔL_{O}(x_{O})+ΔL_{I}(x_{I})=ΔL_{O}(x_{O})+ΔL_{I}(β_{F}·x_{O})=0 (2)

where β_{F} is a lateral magnification in the conjugate relation between the wavefront disturbing element 5 and the wavefront restoring element 6 with respect to the field lens 4 and is expressed by Expression (3).

β_{F}=−b_{F}/a_{F} (3)

When a single light ray R enters the imaging optical system 1 and passes through the position x_{O} on the wavefront disturbing element 5, the single light ray R is subjected to a phase modulation of ΔL_{O}(x_{O}), thus becoming disturbed light rays R_{C} due to refraction, diffraction, scattering, etc. The disturbed light rays R_{C} are projected, together with components of the light ray R that are not subjected to the phase modulation, onto a position x_{I}=β_{F}·x_{O} on the wavefront restoring element 6 by the field lens 4. When passing through this position, the projected light rays are subjected to a phase modulation of ΔL_{I}(β_{F}·x_{O})=−ΔL_{O}(x_{O}), thus cancelling out the phase modulation given by the wavefront disturbing element 5. Accordingly, the light rays become a single light ray R′ having no wavefront disturbance.

When the wavefront disturbing element 5 and the wavefront restoring element 6 have a conjugate positional relation and have the characteristics in Expression (2), a light ray that has passed through one position on the wavefront disturbing element 5 and that has been subjected to a phase modulation always passes through a particular position on the wavefront restoring element 6 that corresponds to the one position in a one-to-one manner and that applies a phase modulation that cancels out the phase modulation given by the wavefront disturbing element 5. The optical system shown in FIGS. 2 and 3 acts with respect to the light ray R as described above, irrespective of the incident position x_{O} and the incident angle on the wavefront disturbing element 5. Specifically, for any light ray R, it is possible to blur an intermediate image II and to clearly form a final image I.

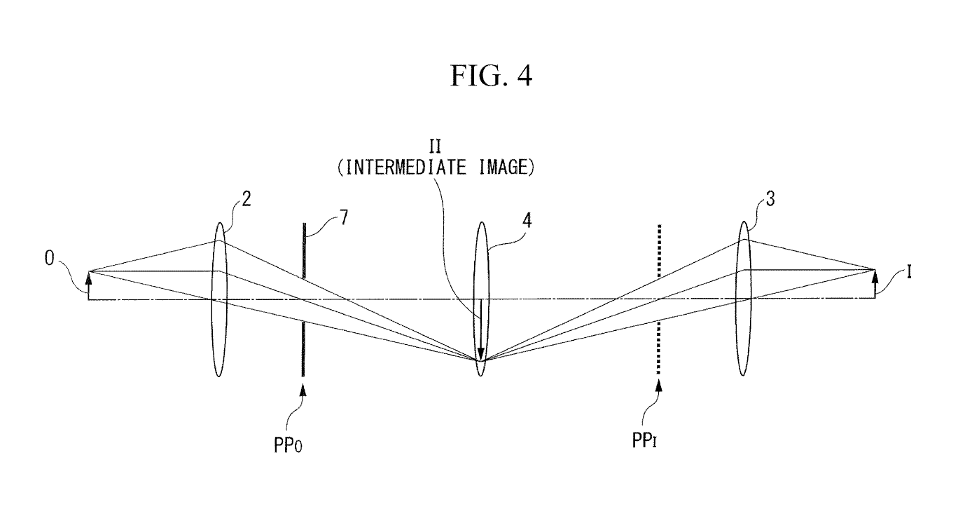

FIG. 4 shows a conventional imaging optical system. In this imaging optical system, light focused by the imaging lens 2, which is close to the object O, is formed into a clear intermediate image II in the field lens 4 disposed in an intermediate image plane and is then focused by the imaging lens 3, which is close to the image I, thus being formed into a clear final image I.

The conventional imaging optical system causes a problem in that, when there is a scratch, dust, or the like on the surface of the field lens 4 or when there is a defect, such as a cavity, in the field lens 4, an image of such a foreign object is overlaid on an intermediate image clearly formed in the field lens 4 and is also formed in the final image I.

On the other hand, according to the imaging optical system 1 of this embodiment, the intermediate image II blurred by the wavefront disturbing element 5 is formed in the intermediate image plane, which is disposed at a position coincident with the field lens 4; therefore, when the blurred intermediate image II is subjected to phase modulation by the wavefront restoring element 6, thus being made clear, the image of a foreign object overlaid on the intermediate image II is blurred through the same phase modulation. Therefore, it is possible to prevent the image of a foreign object in the intermediate image plane from being overlaid on the clear final image I.

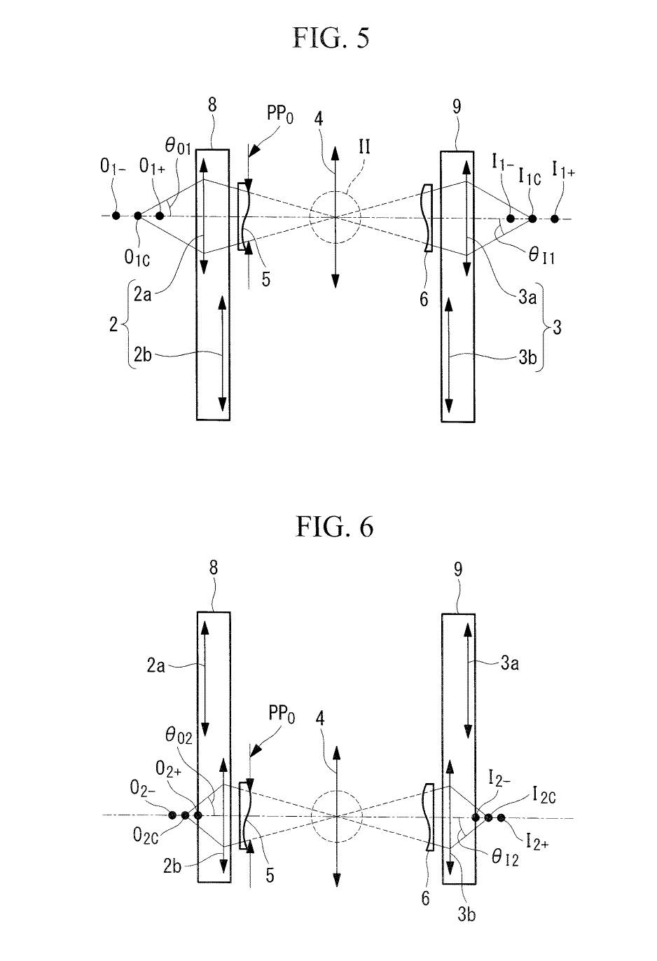

Here, in the imaging optical system 1 of this embodiment, as shown in FIGS. 5 and 6, an imaging lens 2a that has a long focal length and an imaging lens 2b that has a shorter focal length than the imaging lens 2a are used as the imaging lens 2, and an imaging lens 3a that has a long focal length and an imaging lens 3b that has a shorter focal length than the imaging lens 3a are used as the imaging lens 3.

Parameters of the imaging lenses 2a and 2b and the imaging lenses 3a and 3b are determined such that, when the imaging lens 2a, which has a long focal length, and the imaging lens 3a, which has a long focal length, are disposed as a pair in the light path, the inclination θ_{c1} of a marginal ray at the object O coincides with the inclination θ_{I1} of the marginal ray at the image I, and such that, when the imaging lens 2b, which has a short focal length, and the imaging lens 3b, which has a short focal length, are disposed as a pair in the light path, the inclination θ_{O2} of a marginal ray at the object O coincides with the inclination θ_{I2} of the marginal ray at the image I.

Furthermore, the imaging optical system 1 of this embodiment is provided with: a switching device (wavefront adjusting means) 8 that switches between the imaging lens 2a and the imaging lens 2b and selectively disposes the imaging lens 2a or 2b in the light path; and a switching device (wavefront adjusting means) 9 that switches between the imaging lens 3a and the imaging lens 3b and selectively disposes the imaging lens 3a or 3b in the light path.

According to the thus-configured imaging optical system 1, as shown in FIG. 5, when the switching device 8 disposes the imaging lens 2a in the light path, the switching device 9 disposes the imaging lens 3a in the light path, thereby making θ_{O1} at the object O and θ_{I1} at the image I equal (θ_{O1}=θ_{I1}) and thus making it possible to satisfy Herschel's condition. In this case, not only is an object point O_{1C} imaged as an image point I_{1C} with no aberrations, but also object points O₁₋ and O₁₊ that are located in front and at rear of the object point O_{1C} are respectively imaged as image points I₁₋ and I₁₊ with no aberrations.

On the other hand, as shown in FIG. 6, when the switching device 8 disposes the imaging lens 2b in the light path, the switching device 9 disposes the imaging lens 3b in the light path, thereby making θ_{O2} at the object O and O_{I2} at the image I equal (θ_{O2}=θ_{I2}) and thus making it possible to satisfy Herschel's condition. In this case, not only is an object point O_{2C} imaged as an image point I_{2C} with no aberrations, but also object points O₂₋ and O₂₊ that are located in front and at rear of the object point O_{2C} are respectively imaged as image points I₂₋ and I₂₊ with no aberrations.

Therefore, according to the imaging optical system 1 of this embodiment, even when θ_{O} is changed by switching between the imaging lenses 2a and 2b, θ_{I} is made to coincide with θ_{O} by switching between the imaging lenses 3a and 3b to satisfy Herschel's condition, thus making it possible to suppress a fluctuation in aberrations caused by a change in magnification or NA (numerical aperture) through switching between imaging lenses.

In this embodiment, a description has been given of an example case in which θ_{O} is changed by switching between the imaging lenses 2a and 2b; however, for example, in a case in which the refractive index of an object space is changed, e.g., when the object space where the object O is disposed is filled with liquid or the like, θ_{I} is made to coincide with θ_{O} by switching between the imaging lenses 3a and 3b, thus making it possible to satisfy Herschel's condition. Therefore, it is possible to suppress a fluctuation in aberrations caused by a change in the refractive index of the object space.

This embodiment can be modified as follows.

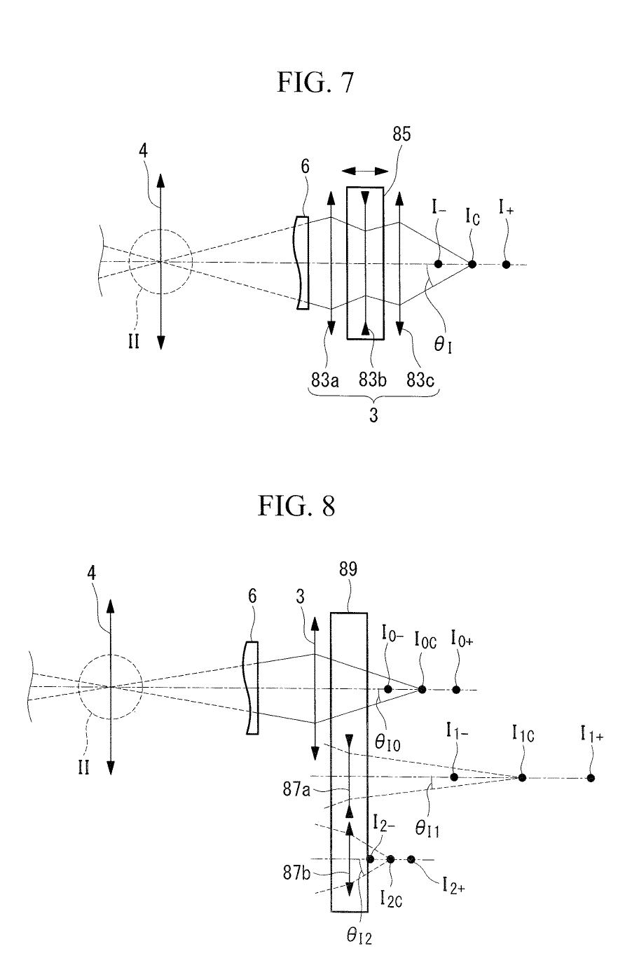

In a first modification, for example, as shown in FIG. 7, the imaging lens 3 may be composed of two convex lenses 83a and 83c and one concave lens 83b that is disposed between the two convex lenses 83a and 83c and that can be moved in the optical axis direction. Furthermore, a movement mechanism 85 that moves the concave lens 83b in the optical axis direction may be adopted as the wavefront adjusting means.

In this case, the concave lens 83b is moved in the optical axis direction, thereby making it possible to change the inclination θ_{I} of the marginal ray at the image I. Therefore, the position of the concave lens 83b in the optical axis direction is adjusted by the movement mechanism 85, thereby making it possible to make θ_{I} coincident with θ_{O} to satisfy Herschel's condition.

Furthermore, in a second modification, for example, as shown in FIG. 8, a conversion lens 87a that makes the focal length longer and a conversion lens 87b that makes the focal length shorter may be disposed, so as to be removably inserted into the light path, at a location that is adjacent to the imaging lens 3 and that is on the image I side of the imaging lens 3. Furthermore, as the wavefront adjusting means, it is possible to adopt a switching mechanism 89 that switches between the conversion lenses 87a and 87b to be selectively disposed in the light path of illumination light. In this case, the switching mechanism 89 switches between the conversion lenses 87a and 87b to be disposed in the optical axis, to make θ_{I} coincident with θ_{O}, thereby making it possible to satisfy Herschel's condition.

Note that although a description has been given above of the case in which the two imaging lenses 2 and 3 are disposed so as to be telecentric, the present invention is not limited thereto, and the same effect is afforded with a non-telecentric system.

Furthermore, the function of the phase lead is a one-dimensional function; however, instead of this, a two-dimensional function can afford the same effect.

Furthermore, spaces between the imaging lens 2, the wavefront disturbing element 5, and the field lens 4 and spaces between the field lens 4, the wavefront restoring element 6, and the imaging lens 3 are not necessarily required, and those elements can be optically bonded.

Furthermore, the lenses constituting the imaging optical system 1, i.e., the imaging lenses 2 and 3 and the field lens 4, distinctly share the functions of image formation and pupil relaying; however, an actual imaging optical system uses a configuration in which one lens has both the functions of image formation and pupil relaying at the same time. In such a case, when the above-described condition is satisfied, the wavefront disturbing element 5 can give a disturbance to the wavefront to blur the intermediate image II, and the wavefront restoring element 6 can cancel out the wavefront disturbance to make the final image I clear.

Next, an observation device 10 according to a first reference embodiment of the present invention will be described below with reference to the drawings.

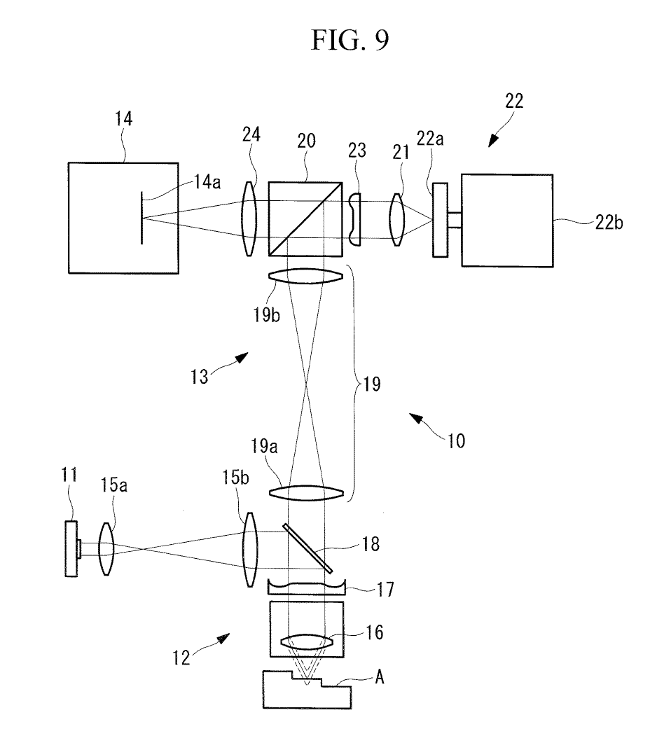

As shown in FIG. 9, the observation device 10 of this embodiment is provided with: a light source 11 that produces non-coherent illumination light; an illumination optical system 12 that radiates the illumination light from the light source 11 onto an observation object A; an imaging optical system 13 that focuses light from the observation object A; and an image acquisition device (photodetector) 14 that acquires an image by imaging the light focused by the imaging optical system 13.

The illumination optical system 12 is provided with: focusing lenses 15a and 15b that focus illumination light from the light source 11; and an objective lens 16 that radiates the illumination light focused by the focusing lenses 15a and 15b onto the observation object A.

Furthermore, the illumination optical system 12 uses so-called Kohler illumination, and the focusing lenses 15a and 15b are provided such that a light-emitting face of the light source 11 and a pupil plane of the objective lens 16 become conjugate with each other.

The imaging optical system 13 is provided with: the objective lens (imaging lens) 16 that focuses observation light (for example, reflected light) produced in the observation object A disposed on the object side; a wavefront disturbing element 17 that gives a disturbance to the wavefront of the observation light focused by the objective lens 16; a first beam splitter 18 that splits off the light whose wavefront has been disturbed, from an illumination light path extending from the light source 11; a first intermediate imaging-lens pair 19 that is provided with a space therebetween in the optical axis direction; a second beam splitter 20 that deflects light that has passed through lenses 19a and 19b of the first intermediate imaging-lens pair 19 by 90 degrees; a second intermediate imaging lens 21 that focuses the light deflected by the second beam splitter 20 to form an intermediate image; an optical-path-length varying means 22 that is disposed in an intermediate image plane of the second intermediate imaging lens 21; a wavefront restoring element 23 that is disposed between the second beam splitter 20 and the second intermediate imaging lens 21; and an imaging lens 24 that focuses light that is transmitted through the wavefront restoring element 23 and the second beam splitter 20, to form a final image.

The image acquisition device 14 is, for example, a two-dimensional image sensor such as a CCD or a CMOS, is provided with an imaging surface 14a that is disposed at an imaging position where the final image is formed by the imaging lens 24, and images light incident thereon, thereby making it possible to acquire a two-dimensional image of the observation object A.

The wavefront disturbing element 17 is disposed in the vicinity of the pupil position of the objective lens 16. The wavefront disturbing element 17 is formed of an optically transparent material through which light can be transmitted and applies, to the wavefront of light when transmitted therethrough, a phase modulation conforming to a concavo-convex shape of the surface thereof. In this embodiment, when observation light from the observation object A is transmitted therethrough once, a required wavefront disturbance is given thereto.

Furthermore, the wavefront restoring element 23 is disposed in the vicinity of the pupil position of the second intermediate imaging lens 21. The wavefront restoring element 23 is also formed of an optically transparent material through which light can be transmitted and applies, to the wavefront of light when transmitted therethrough, a phase modulation conforming to a concavo-convex shape of the surface thereof. In this embodiment, when the observation light that has been deflected by the second beam splitter 20 and observation light that has been reflected, so as to turn around, at the optical-path-length varying means 22 are transmitted through the wavefront restoring element 23 two times in a round trip, the wavefront restoring element 23 applies, to the wavefront of the light, a phase modulation that cancels out the wavefront disturbance given by the wavefront disturbing element 17.

The optical-path-length varying means 22, which serves as an optical-axis (Z-axis) scanning system, is provided with: a plane mirror 22a that is provided so as to be perpendicular to the optical axis and an actuator 22b that displaces the plane mirror 22a in the optical axis direction. When the plane mirror 22a is displaced in the optical axis direction through the actuation of the actuator 22b of the optical-path-length varying means 22, the optical path length between the second intermediate imaging lens 21 and the plane mirror 22a is changed, thereby changing a position, in the observation object A, that is conjugate with the imaging surface 14a, i.e., the focal position in front of the objective lens 16, in the optical axis direction.

The imaging lens 24 is disposed in a pupil conjugate plane.

In order to observe the observation object A by using the thus-configured observation device 10 of this embodiment, illumination light from the light source 11 is radiated onto the observation object A by the illumination optical system 12. Observation light produced in the observation object A is focused by the objective lens 16, is transmitted through the wavefront disturbing element 17 once, passes through the first beam splitter 18 and the first intermediate imaging-lens pair 19, is deflected at the second beam splitter 20 by 90 degrees, is transmitted through the wavefront restoring element 23, is reflected, so as to turn around, at the plane mirror 22a of the optical-path-length varying means 22, is transmitted through the wavefront restoring element 23 again, and is transmitted through the second beam splitter 20, and a final image formed by the imaging lens 24 is acquired by the image acquisition device 14.

When the plane mirror 22a is moved in the optical axis direction by actuating the actuator 22b of the optical-path-length varying means 22, the optical path length between the second intermediate imaging lens 21 and the plane mirror 22a can be changed, thereby making it possible to move the focal position in front of the objective lens 16 in the optical axis direction to perform scanning. Then, the observation light is imaged at different focal positions, thereby making it possible to acquire a plurality of images focused at different positions in the observation object A in the depth direction. Furthermore, these images are composited through averaging and are then subjected to high-frequency enhancement processing, thereby making it possible to acquire an image with a large depth of field.

In this case, although an intermediate image is formed, by the second intermediate imaging lens 21, in the vicinity of the plane mirror 22a of the optical-path-length varying means 22, this intermediate image is blurred due to a wavefront disturbance that remains after a wavefront disturbance given to the wavefront of light when transmitted through the wavefront disturbing element 17 is partially cancelled out when transmitted through the wavefront restoring element 23 once. Then, the light, after being formed into the blurred intermediate image, is focused by the second intermediate imaging lens 21 and is then made to pass through the wavefront restoring element 23 again, thereby completely cancelling out the wavefront disturbance.

As a result, according to the observation device 10 of this embodiment, there is an advantage in that, even when a foreign object, such as a scratch or dust, exists on the surface of the plane mirror 22a, it is possible to prevent an image of the foreign object from being formed while being overlaid on a final image and to acquire a clear image of the observation object A.

Furthermore, in the same way, when the focal position in the observation object A is moved in the optical axis direction, an intermediate image formed by the first intermediate imaging-lens pair 19 is largely fluctuated in the optical axis direction; however, as a result of the fluctuation, even when the intermediate image overlaps with the position of the first intermediate imaging-lens pair 19, or, even when any other optical element exists within the fluctuation range, because the intermediate image is blurred, it is possible to prevent an image of the foreign object from being formed while being overlaid on the final image. In this embodiment, in the case where the above-described scanning system is provided, even when light is moved along the Z-axis on any optical element disposed in the imaging optical system, a noise image is not formed.

Next, an observation device (microscope apparatus) 120 according to a first embodiment of the present invention will be described below with reference to the drawings.

In this embodiment, identical reference signs are assigned to portions having configurations common to those of the observation device 10 of the above-described first reference embodiment, and a description thereof will be omitted.

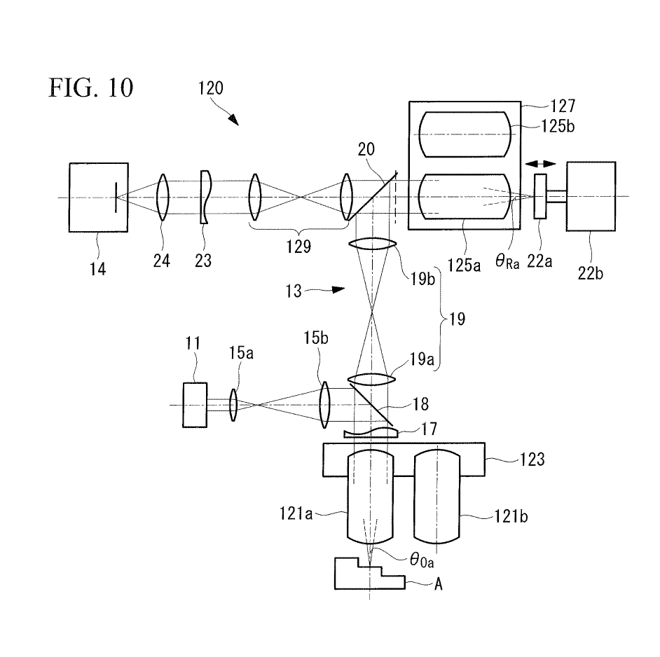

As shown in FIG. 10, in the observation device 120 of this embodiment, instead of the objective lens 16, the imaging optical system 13 is provided with: an objective lens (imaging lens) 121a that has a long focal length and low magnification; an objective lens (imaging lens) 121b that has a shorter focal length and higher magnification than the objective lens 121a; and a revolver (wavefront adjusting means) 123 that holds the objective lenses 121a and 121b and can selectively insert the objective lens 121a or 121b in the light path of illumination light.

Furthermore, as shown in the same figure, instead of the second intermediate imaging lens 21, the observation device 120 is provided with: a relay lens 125a that has a long focal length and a small NA; a relay lens 125b that has a shorter focal length and a larger NA than the relay lens 125a; and a switching mechanism (wavefront adjusting means) 127 that switches between the relay lenses 125a and 125b to be selectively disposed in the light path of illumination light. The relay lenses 125a and 125b relay light deflected by the second beam splitter 20 to the plane mirror 22a of the optical-path-length varying means 22.

Furthermore, the observation device 120 is provided with a relay lens 129 that relays light having turned around at the optical-path-length varying means 22 and having been transmitted through the second beam splitter 20, and the wavefront restoring element 23 is disposed between the relay lens 129 and the imaging lens 24.

In this embodiment, parameters of the objective lenses 121a and 121b and the relay lenses 125a and 125b are determined such that, when the objective lens 121a, which has a long focal length and low magnification, and the relay lens 125a, which has a long focal length and a small NA, are disposed as a pair in the light path, the inclination θ_{Oa} of the marginal ray at the objective lens 121a coincides with the inclination θ_{Ra} of the marginal ray at the relay lens 125a, and such that, when the objective lens 121b, which has a short focal length and high magnification, and the relay lens 125b, which has a short focal length and a large NA, are disposed as a pair in the light path, the inclination θ_{Ob} of the marginal ray at the objective lens 121b coincides with the inclination θ_{Rb} of the marginal ray at the relay lens 125b.

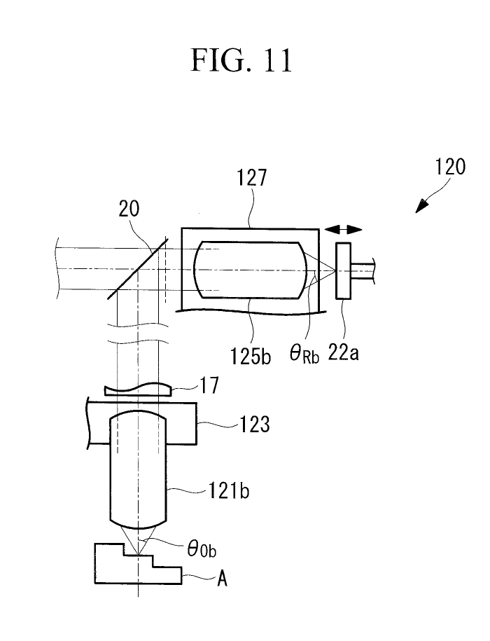

As shown in FIG. 10, in the thus-configured observation device 120, when the revolver 123 disposes the objective lens 121a in the light path, the switching mechanism 127 disposes the relay lens 125a in the light path, thereby establishing θ_{Oa}=θ_{Ra} and thus making it possible to satisfy Herschel's condition. Furthermore, as shown in FIG. 11, when the revolver 123 disposes the objective lens 121b in the light path, the switching mechanism 127 disposes the relay lens 125b in the light path, thereby establishing θ_{Ob}=θ_{Rb} and thus making it possible to satisfy Herschel's condition.

Therefore, according to the observation device 120 of this embodiment, when the optical-path-length varying means 22 changes the optical path length between the relay lens 125a or 125b and the plane mirror 22a, to move (Z-axis scan) the focal position, in the observation object A, in front of the objective lens 121a or 121b, it is possible to suppress a fluctuation in aberrations by switching between the relay lenses 125a and 125b.

Next, an observation device 30 according to a second reference embodiment of the present invention will be described below with reference to the drawings.

In this embodiment, identical reference signs are assigned to portions having configurations common to those of the observation device 10 of the above-described first reference embodiment, and a description thereof will be omitted.

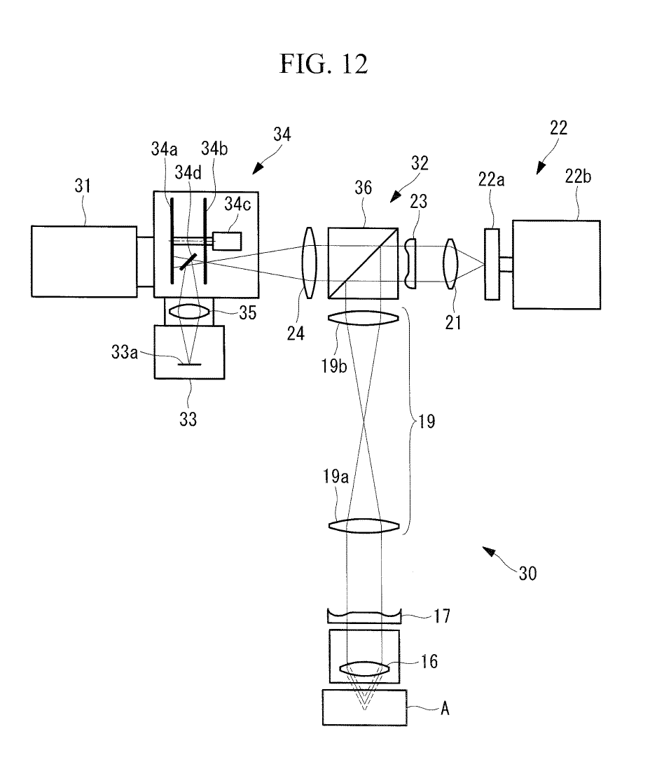

As shown in FIG. 12, the observation device 30 of this embodiment is provided with: a laser light source 31; an imaging optical system 32 that focuses laser light from the laser light source 31 on the observation object A and that focuses light from the observation object A; an image acquisition device (photodetector) 33 that images light focused by the imaging optical system 32; and a Nipkow-disk confocal optical system 34 that is disposed among the light source 31, the image acquisition device 33, and the imaging optical system 32. The laser light source 31 and the imaging optical system 32 constitute an illuminating device.

The Nipkow-disk confocal optical system 34 is provided with: two disks 34a and 34b that are disposed in parallel with a space therebetween; and an actuator 34c that simultaneously rotates the disks 34a and 34b. A large number of microlenses (not shown) are arrayed on the disk 34a, which is close to the laser light source 31, and a large number of pinholes (not shown) are provided in the disk 34b, which is close to the object, at positions corresponding to the microlenses. Furthermore, a dichroic mirror 34d that splits off light passing through the pinholes is fixed in the space between the two disks 34a and 34b, light split off at the dichroic mirror 34d is focused by a focusing lens 35 and is formed into a final image on an imaging surface 33a of the image acquisition device 33, and an image thereof is acquired.

The imaging optical system 32 adopts a single beam splitter 36 by unifying the first beam splitter 18 and the second beam splitter 20 of the first reference embodiment, thus completely unifying a light path for radiating light passing through the pinholes in the Nipkow-disk confocal optical system 34 onto the observation object A and a light path for causing light produced in the observation object A to enter the pinholes in the Nipkow-disk confocal optical system 34.

The operation of the thus-configured observation device 30 of this embodiment will be described below.

According to the observation device 30 of this embodiment, light entering the imaging optical system 32 from the pinholes in the Nipkow-disk confocal optical system 34 is transmitted through the beam splitter 36 and the phase modulation element 23, is focused by the second intermediate imaging lens 21, and is reflected, so as to turn around, at the plane mirror 22a of the optical-path-length varying means 22. Then, the light passes through the second intermediate imaging lens 21, is transmitted through the phase modulation element 23 again, is deflected at the beam splitter 36 by 90 degrees, is transmitted through the first intermediate imaging-lens pair 19 and the phase modulation element 17, and is focused by the objective lens 16 on the observation object A.

In this embodiment, the phase modulation element 23, through which laser light is first transmitted two times, functions as a wavefront disturbing element for giving a disturbance to the wavefront of the laser light, and the phase modulation element 17, through which the laser light is then transmitted once, functions as a wavefront restoring element for applying a phase modulation that cancels out the wavefront disturbance given by the phase modulation element 23.

Therefore, although an image of the light source formed into a number of point light sources by the Nipkow-disk confocal optical system 34 is formed as an intermediate image on the plane mirror 22a by the second intermediate imaging lens 21, because the intermediate image formed by the second intermediate imaging lens 21 is blurred when passing through the phase modulation element 23 once, it is possible to prevent a disadvantage that an image of a foreign object existing in the intermediate image plane is overlaid on the final image.

Furthermore, because the disturbance given to the wavefront of light when the light is transmitted through the phase modulation element 23 two times is cancelled out when transmitted through the phase modulation element 17 once, a clear image of a number of point light sources can be formed in the observation object A. Then, the disks 34a and 34b are rotated by actuating the actuator 34c of the Nipkow-disk confocal optical system 34, thereby making it possible to move the image of a number of point light sources formed in the observation object A in XY directions intersecting the optical axis and to perform fast scanning.

On the other hand, light, for example, fluorescence, produced at the imaging position in the observation object A where the image of point light sources is formed is focused by the objective lens 16, is transmitted through the phase modulation element 17 and the first intermediate imaging-lens pair 19, is deflected at the beam splitter 36 by 90 degrees, is transmitted through the phase modulation element 23, is focused by the second intermediate imaging lens 21, and is reflected, so as to turn around, at the plane mirror 22a. Then, the light is focused by the second intermediate imaging lens 21 again, is transmitted through the phase modulation element 23 and the beam splitter 36, is focused by the imaging lens 24, and is formed into an image at positions of the pinholes in the Nipkow-disk confocal optical system 34.

The light passing through the pinholes is split off by the dichroic mirror from the light path extending from the laser light source, is focused by the focusing lens, and is formed as a final image on the imaging surface of the image acquisition device.

In this case, the phase modulation element 17, through which the fluorescence produced in the observation object in the form of a number of points is transmitted, functions as a wavefront disturbing element, as in the first reference embodiment, and the phase modulation element 23 functions as a wavefront restoring element.

Therefore, although a disturbance given to the wavefront of fluorescence when the fluorescence is transmitted through the phase modulation element 17 is partially cancelled out when transmitted through the phase modulation element 23 once, an intermediate image to be formed on the plane mirror 22a is blurred. Then, the fluorescence in which the wavefront disturbance is completely cancelled out when transmitted through the phase modulation element 23 again is imaged in the pinholes in the Nipkow-disk confocal optical system 34, passes through the pinholes, is split off at the dichroic mirror 34d, and is focused by the focusing lens 35, thus being formed into a clear final image on the imaging surface 33a of the image acquisition device 33.

Thus, according to the observation device 30 of this embodiment, as an illuminating device that radiates laser light onto the observation object A and also as an observation device that images fluorescence produced in the observation object A, there is an advantage that it is possible to acquire a clear final image while blurring an intermediate image and preventing an image of a foreign object in the intermediate image plane from being overlaid on the final image. In this embodiment, in the case where the above-described scanning system is provided, even when light is moved along the Z-axis on any optical element disposed in the imaging optical system, a noise image is not formed.

Next, the observation device of the present invention can be applied to the observation device 30 that is provided with the Nipkow-disk confocal optical system 34 of the above-described second reference embodiment. In this case, instead of the objective lens 16 of the observation device 30 shown in FIG. 12, the objective lenses 121a and 121b and the revolver 123 are adopted, as in the first embodiment of the present invention, shown in FIG. 10; and the relay lenses 125a and 125b and the switching mechanism 127 are adopted instead of the second intermediate imaging lens 21. Furthermore, the relay lens 129 and the wavefront restoring element 23 are disposed between the second beam splitter 20 and the imaging lens 24.

Next, an observation device 40 according to a third reference embodiment of the present invention will be described below with reference to the drawings.

In this embodiment, identical reference signs are assigned to portions having configurations common to those of the observation device 30 of the above-described second reference embodiment, and a description thereof will be omitted.

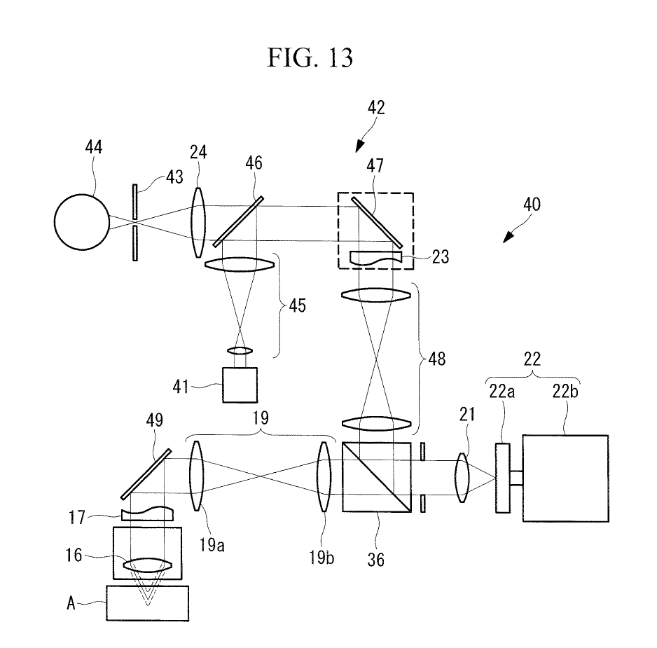

As shown in FIG. 13, the observation device 40 of this embodiment is a laser-scanning confocal observation device.

The observation device 40 is provided with: a laser light source 41; an imaging optical system 42 that focuses the laser light from the laser light source 41 on the observation object A and that focuses light from the observation object A; a confocal pinhole 43 through which fluorescence focused by the imaging optical system 42 is made to pass; and a photodetector 44 that detects the fluorescence that has passed through the confocal pinhole 43.

The imaging optical system 42 is provided with: a beam expander 45 that expands the beam diameter of laser light; a dichroic mirror 46 that deflects the laser light and that transmits fluorescence; a galvanometer mirror 47 that is disposed in the vicinity of a position conjugate with the pupil of the objective lens 16; and a third intermediate imaging-lens pair 48, as different components from the observation device 30 of the second reference embodiment. Furthermore, the phase modulation element 23, which gives a disturbance to the wavefront of laser light, is disposed in the vicinity of the galvanometer mirror 47. In the figure, reference sign 49 denotes a mirror.

The operation of the thus-configured observation device 40 of this embodiment will be described below.

According to the observation device 40 of this embodiment, the beam diameter of laser light produced in the laser light source 41 is expanded by the beam expander 45, and the laser light is deflected by the dichroic mirror 46, is two-dimensionally scanned by the galvanometer mirror 47, passes through the phase modulation element 23 and the third intermediate imaging-lens pair 48, and enters the beam splitter 36. After entering the beam splitter 36, the laser light travels in the same way as in the observation device 30 of the second reference embodiment.

Specifically, after a disturbance is given to the wavefront of the laser light by the phase modulation element 23, the laser light is formed into an intermediate image on the plane mirror 22a of the optical-path-length varying means 22; therefore, the intermediate image is blurred, thus making it possible to prevent overlaying of an image of a foreign object existing in the intermediate image plane. Furthermore, the wavefront disturbance is cancelled out by the phase modulation element 17, which is disposed at the pupil position of the objective lens 16, thus making it possible to form a clear final image on the observation object A. Furthermore, the imaging depth of the final image can be desirably adjusted by the optical-path-length varying means 22.

On the other hand, fluorescence produced at the imaging position, in the observation object A, where the final image of the laser light is formed is focused by the objective lens 16, is transmitted through the phase modulation element 17, travels in the light path in the opposite direction from the laser light, is deflected by the beam splitter 36, passes through the third intermediate imaging-lens pair 48, the phase modulation element 23, the galvanometer mirror 47, and the dichroic mirror 46, and is focused by the imaging lens 24 on the confocal pinhole 43, and only fluorescence that has passed through the confocal pinhole 43 is detected by the photodetector 44.

In this case, because the fluorescence focused by the objective lens 16 is subjected to a disturbance given to the wavefront thereof by the phase modulation element 17 and is then formed into an intermediate image, the intermediate image is blurred, thus making it possible to prevent overlaying of an image of a foreign object existing in the intermediate image plane. Then, the wavefront disturbance is cancelled out when the fluorescence is transmitted through the phase modulation element 23, thus making it possible to form a clear image in the confocal pinhole 43 and to efficiently detect the fluorescence produced at the imaging position, in the observation object A, where the final image of the laser light is formed. As a result, there is an advantage that a high-resolution bright confocal image can be acquired. In this embodiment, in the case where the above-described scanning system is provided, even when light is moved along the Z-axis on any optical element disposed in the imaging optical system, a noise image is not formed.

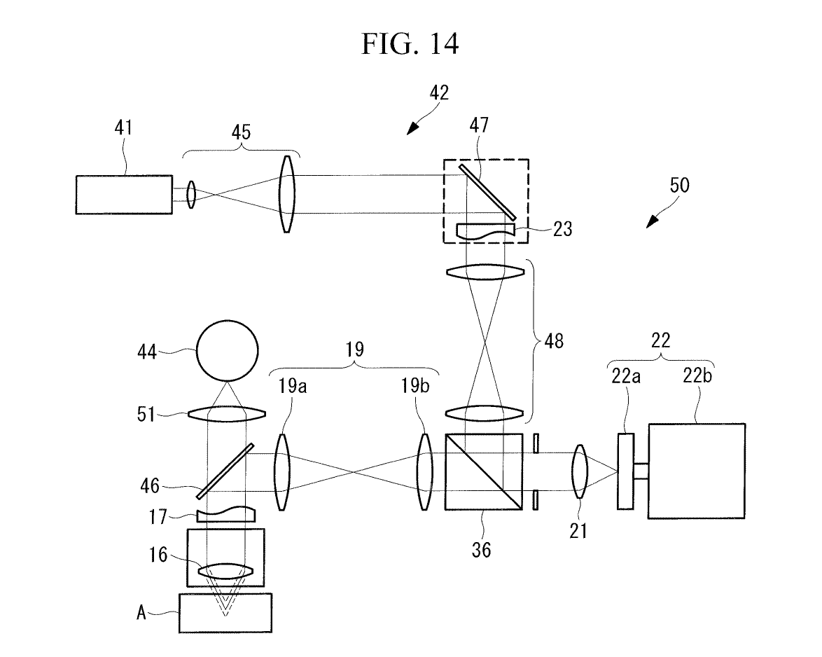

Note that, in this embodiment, the laser-scanning confocal observation device has been described as an example; however, instead of this, as shown in FIG. 14, the present invention can be applied to a laser-scanning multiphoton excitation observation device.

In this case, it is necessary to adopt an extremely-short pulse laser light source, such as a titanium sapphire laser, as the laser light source 41, to eliminate the dichroic mirror 46, and to adopt the dichroic mirror 46 instead of the mirror 49.

In an observation device 50 shown in FIG. 14, in the function of an illuminating device that radiates extremely-short pulse laser light onto the observation object A, it is possible to blur an intermediate image and to make a final image clear. Fluorescence produced in the observation object A is focused by the objective lens 16, is transmitted through the phase modulation element 17 and the dichroic mirror 46, is focused by a focusing lens 51, and is detected by the photodetector 44 as is, without being formed into an intermediate image.

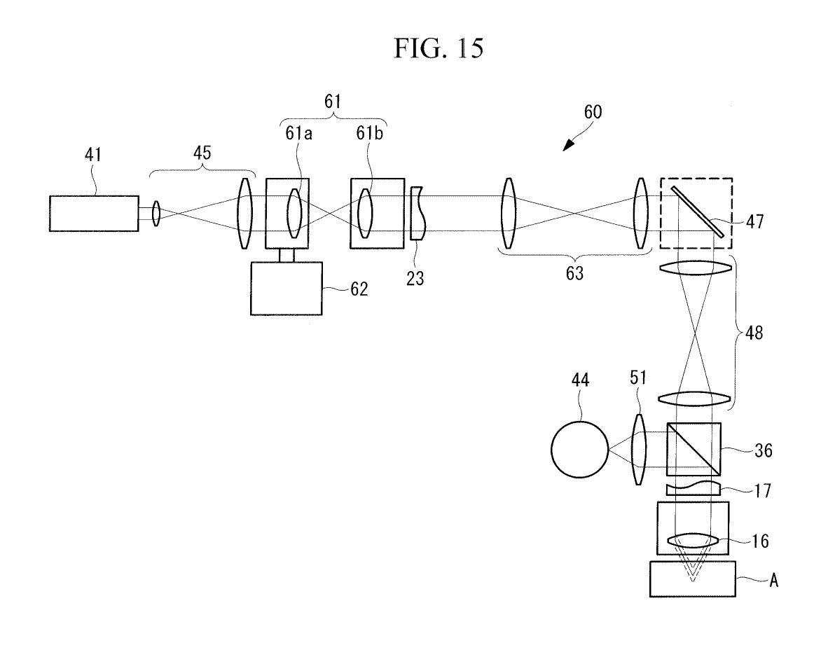

Furthermore, in the above-described embodiments, the focal position in front of the objective lens is changed in the optical axis direction by the optical-path-length varying means 22, which changes the optical-path length by moving the plane mirror, at which the light path turns around. Instead of this, as shown in FIG. 15, it is also possible to configure an observation device 60 that adopts a configuration in which a lens 61a that is one of lenses 61a and 61b constituting an intermediate imaging optical system 61 is moved in the optical axis direction by an actuator 62, thus changing the optical-path length. In the figure, reference sign 63 denotes another intermediate imaging optical system.

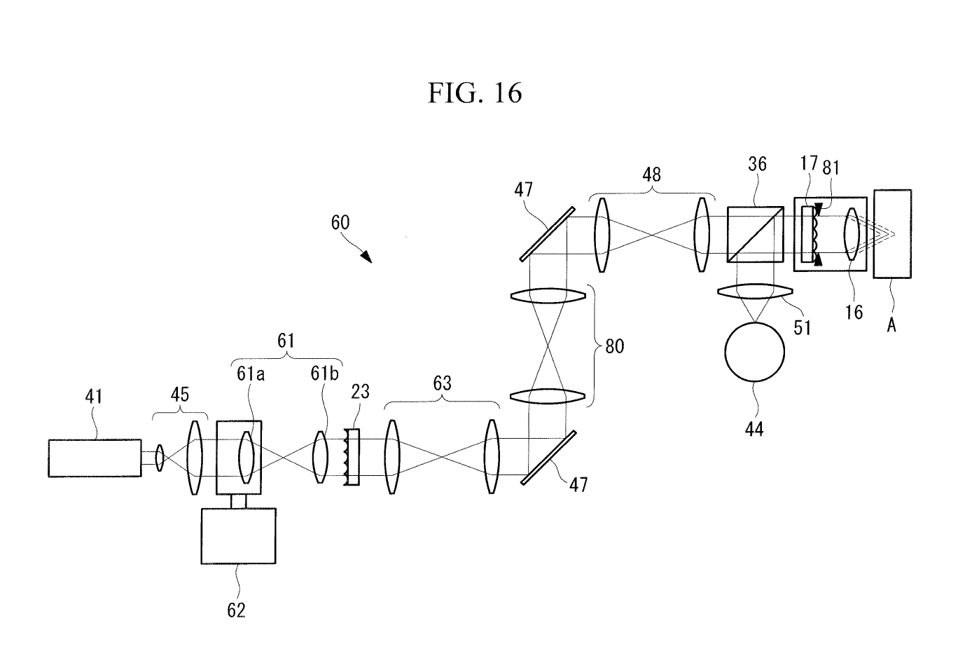

Furthermore, as shown in FIG. 16, it is also possible to dispose another intermediate imaging optical system 80 between two galvanometer mirrors 47 that constitute a two-dimensional optical scanner and to accurately dispose the two galvanometer mirrors 47 so as to have optically conjugate positional relations with the phase modulation elements 17 and 23 and an aperture stop 81 that is disposed at the pupil of the objective lens 16.

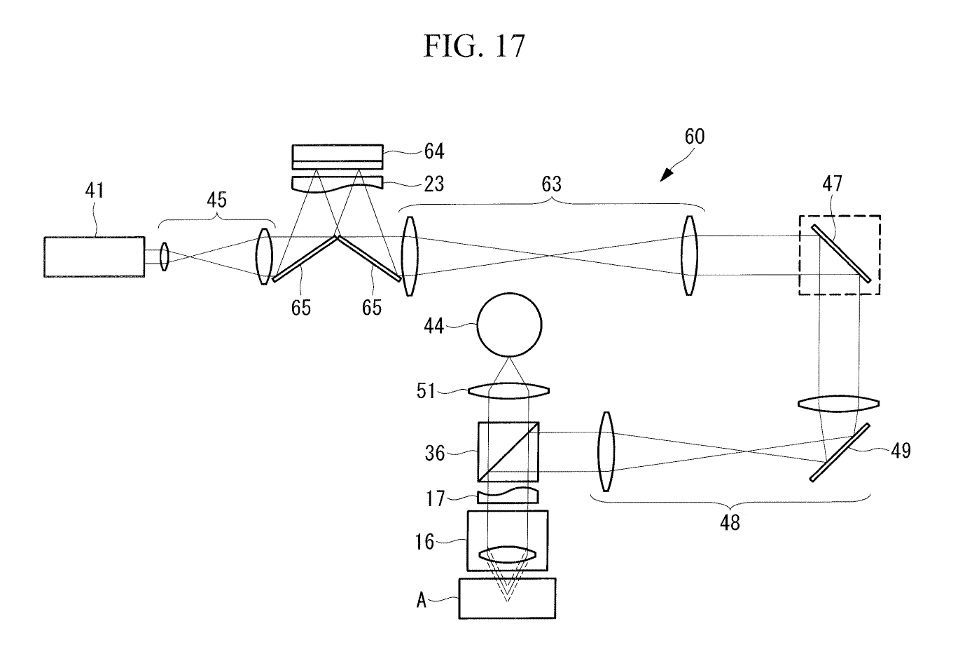

Furthermore, as the optical-path-length varying means, as shown in FIG. 17, it is also possible to adopt a spatial light modulating element (SLM) 64, such as a reflective LCOS. By doing so, it is possible to rapidly change the phase modulation to be applied to the wavefront through control of the liquid crystal of the LCOS and to rapidly change the focal position in front of the objective lens 16 in the optical axis direction. In the figure, reference sign 65 denotes mirrors.

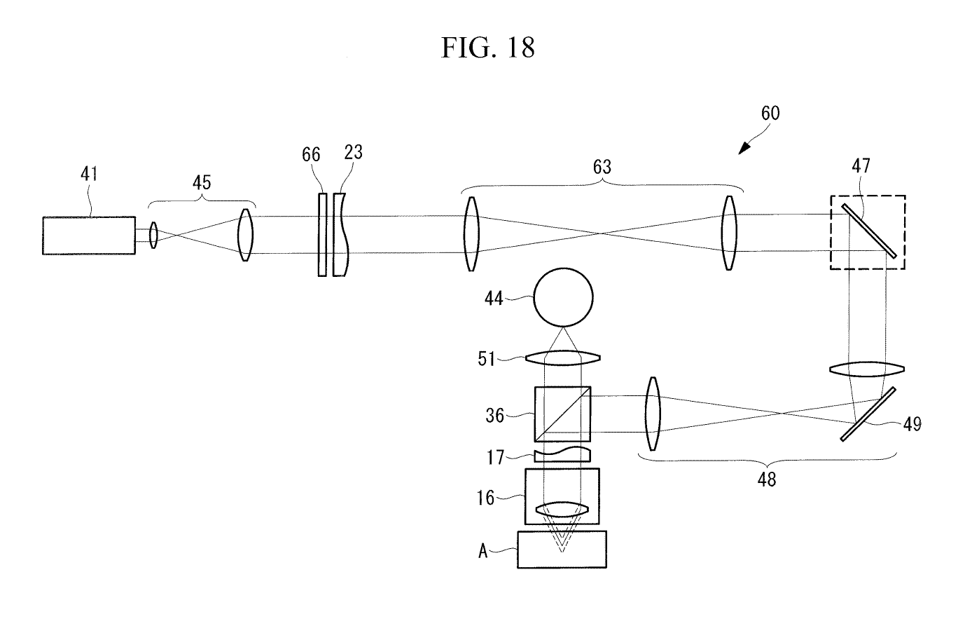

Furthermore, instead of the spatial light modulating element 64, such as a reflective LCOS, as shown in FIG. 18, it is also possible to adopt a spatial light modulating element 66, such as a transmissive LCOS. Compared with the reflective LCOS, the mirrors 65 are eliminated, thus making it possible to simplify the configuration.

As the means for moving the focal position in the observation object A in the optical axis direction, other than the means (the optical-path-length varying means 22, the intermediate imaging optical system 61 and the actuator 62, the reflective spatial light modulating element 64, and the transmissive spatial light modulating element 66) described in the above-described embodiments, various types of variable-power optical elements known as active optical elements can be used, and examples of elements having a mechanically movable part include a deformable mirror (DFM) and a deformable lens using a liquid or gel. Examples of similar elements having no mechanically movable part include a liquid crystal lens and a potassium tantalum niobate (KTN: KTa_{1-X}Nb_{X}O₃) crystal lens that control the refractive index of a medium by using the electric field and a lens to which a cylindrical lens effect in an acousto-optical deflector (AOD) is applied.

Next, an observation device (microscope apparatus) 130 according to a second embodiment of the present invention will be described with reference to the drawings.

In this embodiment, identical reference signs are assigned to portions having configurations common to those of the observation device 40 of the above-described third reference embodiment and modifications thereof, and a description thereof will be omitted.

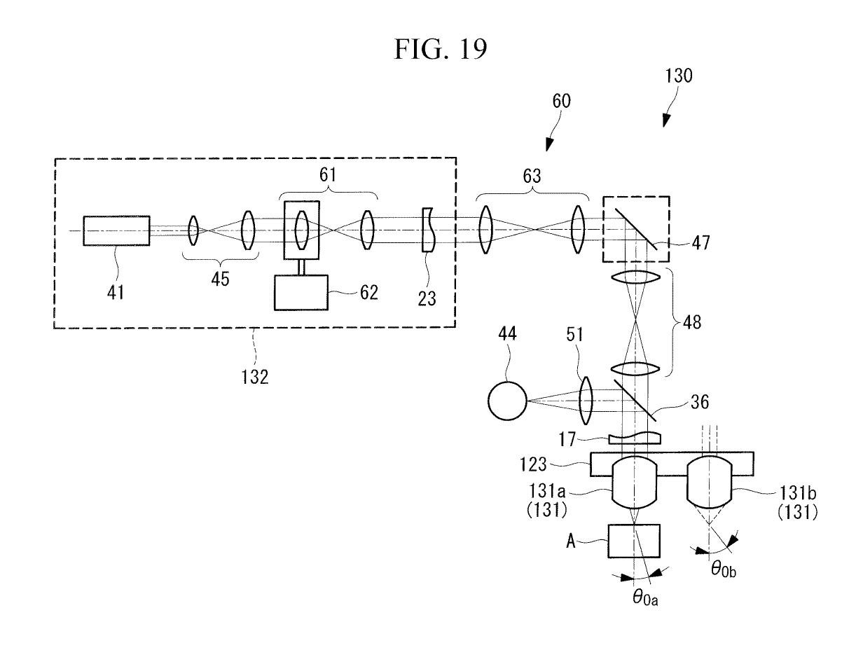

As shown in FIG. 19, the observation device 130 of this embodiment differs from the observation device 40 of the third reference embodiment in the provision of an objective lens 131 and an illumination optical system 132. Specifically, as shown in the same figure, the observation device 130 of this embodiment is provided with, instead of the objective lens 16, an objective lens (imaging lens) 131a that has low magnification, a small NA, and a large pupil diameter, and an objective lens (imaging lens) 131b that has higher magnification, a larger NA, and a smaller pupil diameter than the objective lens 131a. The objective lenses 131a and 131b are held by a revolver 123 and are selectively disposed in the light path of illumination light by the revolver 123.

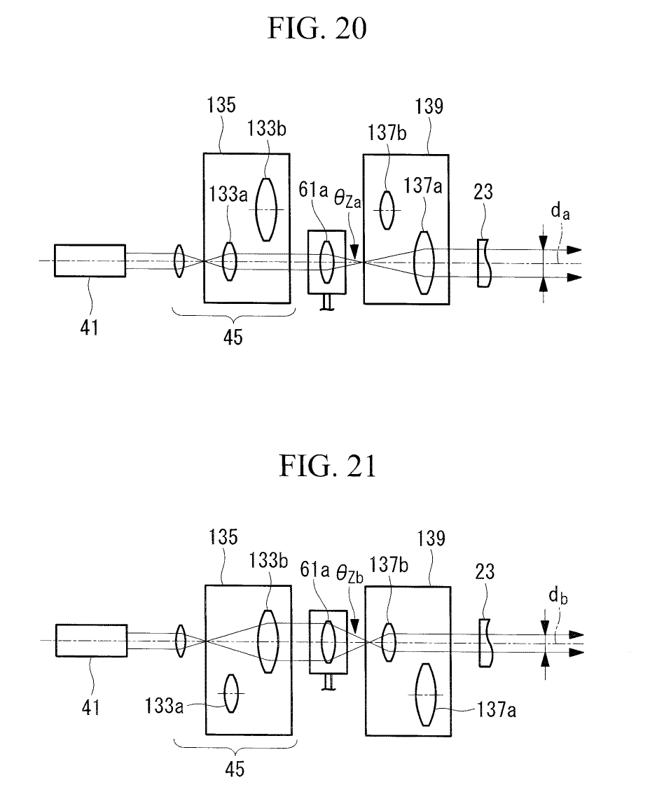

Furthermore, as shown in FIG. 20, the observation device 130 is provided with, as second lenses of the beam expander 45, a second lens 133a that has a short focal length and a second lens 133b that has a longer focal length than the second lens 133a, and a switching mechanism (wavefront adjusting means) 135 that switches between the second lenses 133a and 133b to be selectively disposed in the light path of illumination light.

Furthermore, as shown in FIG. 20, the observation device 130 is provided with, instead of the collimating lens 61b, which constitutes the intermediate imaging optical system 61 shown in FIG. 15, a collimator lens 137a that has a long focal length and a collimator lens 137b that has a shorter focal length than the collimator lens 137a, and a switching mechanism (wavefront adjusting means) 139 that switches between the collimator lenses 137a and 137b to be selectively disposed in the light path of illumination light.

In this embodiment, parameters of the objective lens 131a, the second lens 133a, and the collimator lens 137a are determined such that, when the objective lens 131a, which has low magnification, a small NA, and a large pupil diameter, the second lens 133a, which has a short focal length, and the collimator lens 137a, which has a long focal length, are disposed, as a combination, in the light path, the inclination θ_{Oa} of the marginal ray at the objective lens 131a coincides with the maximum inclination angle θ_{Za} at the light flux of illumination light focused by the lens 61a, and the diameter of the light flux of illumination light that is made to enter the objective lens 131a coincides with the pupil diameter of the objective lens 131a. In the same way, parameters of the objective lens 131b, the second lens 133b, and the collimator lens 137b are determined such that, when the objective lens 131b, which has high magnification, a large NA, and a small pupil diameter, the second lens 133b, which has a long focal length, and the collimator lens 137b, which has a short focal length, are disposed, as a combination, in the light path, the inclination θ_{Ob} of the marginal ray at the objective lens 131b coincides with the maximum inclination angle θ_{Zb} at the light flux of illumination light focused by the lens 61a, and the diameter of the light flux of the illumination light that is made to enter the objective lens 131b coincides with the pupil diameter of the objective lens 131b.

According to the thus-configured observation device 130, as shown in FIG. 20, when the revolver 123 disposes the objective lens 131a in the light path, the switching mechanism 135 disposes the second lens 133a in the light path, thereby making it possible to reduce the diameter of the light flux of illumination light emitted from the beam expander 45, thus reducing the maximum inclination angle θ_{Za} at the light flux of illumination light collected by the lens 61a, and to make θ_{Za} coincident with the inclination θ_{Oa} of the marginal ray at the objective lens 131a to satisfy Herschel's condition. In this case, the switching mechanism 139 disposes the collimator lens 137a in the light path, and the collimator lens 137a collimates illumination light focused by the lens 61a, thereby making it possible to increase the diameter of the emitted light flux and to allow illumination light having a light flux diameter coincident with the pupil diameter of the objective lens 131a to enter the objective lens 131a.

On the other hand, as shown in FIG. 21, when the revolver 123 disposes the objective lens 131b in the light path, the switching mechanism 135 disposes the second lens 133b in the light path, thereby making it possible to increase the diameter of the light flux of illumination light emitted from the beam expander 45, thus increasing the maximum inclination angle θ_{Zb} at the light flux of illumination light collected by the lens 61a, and to make θ_{Zb} coincident with the inclination θ_{Ob} of the marginal ray at the objective lens 131b to satisfy Herschel's condition. In this case, the switching mechanism 139 disposes the collimator lens 137b in the light path, and the collimator lens 137b collimates illumination light focused by the lens 61a, thereby making it possible to reduce the diameter of the emitted light flux and to allow illumination light having a light flux diameter coincident with the pupil diameter of the objective lens 131b to enter the objective lens 131b.

Therefore, according to the observation device 130 of this embodiment, when the objective lenses 131a and 131b are switched, it is possible to satisfy Herschel's condition, thus suppressing a fluctuation in aberrations, and to allow just the right amount of illumination light for the pupil diameter of the objective lens 131a or 131b to enter the objective lens 131a or 131b, thus providing adequate optical performance.

This embodiment can be modified as follows.

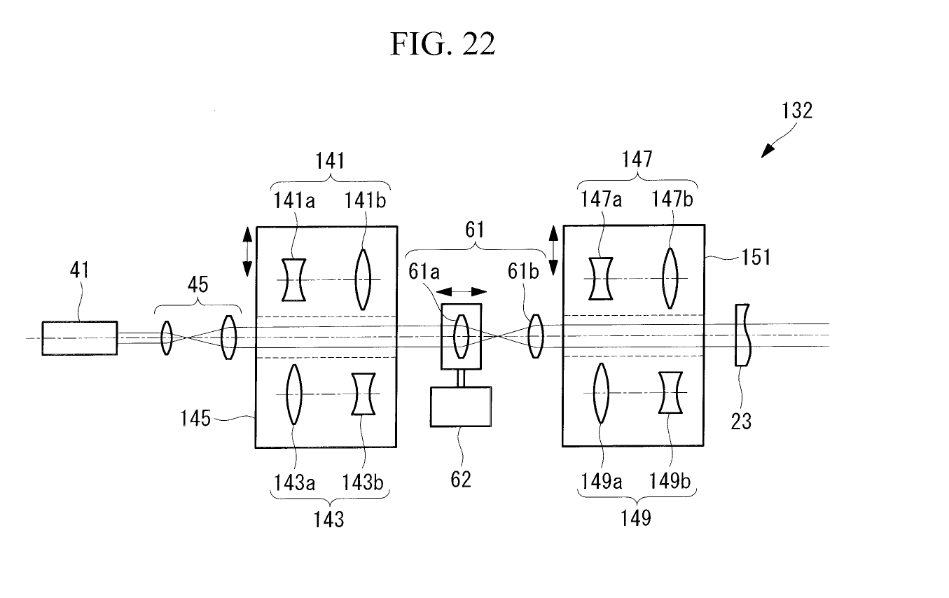

As a first modification, for example, as shown in FIG. 22, the illumination optical system 132 may be provided with: a magnifying optical system 141 that is formed of a concave lens 141a and a convex lens 141b constituting a pair and that expands the diameter of a light flux; a reduction optical system 143 that is formed of a convex lens 143a and a concave lens 143b constituting a pair and that reduces the diameter of a light flux; a switching mechanism 145 that switches among a state in which the magnifying optical system 141 is disposed in the light path, a state in which the reduction optical system 143 is disposed therein, and a state in which neither of them is disposed in the light path to let illumination light pass through this section. Thus, the diameter of the light flux of illumination light between the beam expander 45 and the lens 61a can be adjusted.

Furthermore, as shown in the same figure, the illumination optical system 132 may be provided with: a magnifying optical system 147 that is formed of a concave lens 147a and a convex lens 147b constituting a pair and that expands the diameter of a light flux; a reduction optical system 149 that is formed of a convex lens 149a and a concave lens 149b constituting a pair and that reduces the diameter of a light flux; and a switching mechanism 151 that switches among a state in which the magnifying optical system 147 is disposed in the light path, a state in which the reduction optical system 149 is disposed therein, and a state in which neither of them is disposed in the light path to let illumination light pass through this section. Thus, the diameter of the light flux of illumination light collimated by the collimating lens 61b can be adjusted.

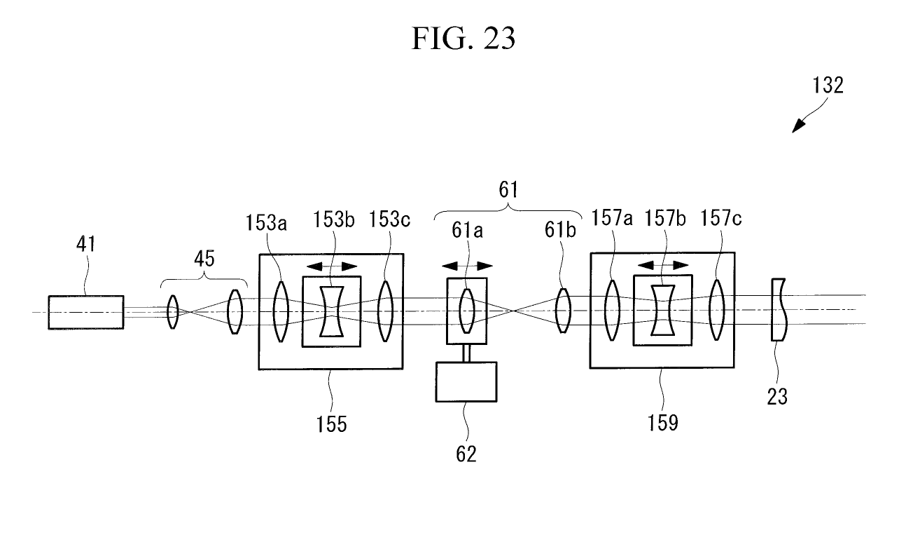

Next, as a second modification, for example, as shown in FIG. 23, the illumination optical system 132 may be provided with: a zoom optical system 153 in which a convex lens 153a, a concave lens 153b, and a convex lens 153c are disposed in this order from the light source 41 side; and a movement mechanism (wavefront adjusting means) 155 that moves the concave lens 153b in the optical axis direction. Thus, the diameter of the light flux of illumination light between the beam expander 45 and the lens 61a can be adjusted.

Furthermore, as shown in the same figure, the illumination optical system 132 may be provided with: a zoom optical system 157 in which a convex lens 157a, a concave lens 157b, and a convex lens 157c are disposed in this order from the intermediate imaging optical system 61 side; and a movement mechanism (wavefront adjusting means) 159 that moves the concave lens 157b in the optical axis direction. Thus, the diameter of the light flux of illumination light collimated by the collimating lens 61b can be adjusted to make the light flux of the illumination light coincident with the pupil diameter of the objective lens 133a or 133b.

As described above, the microscopes of the embodiments of the present invention each have any means for moving the focal position in the observation object A in the optical axis direction. Furthermore, compared with a means (that moves one of an objective lens and an observation object in the optical axis direction) used in a conventional microscope for the same purpose, these focal-position optical-axis-wise moving means are capable of significantly increasing the movement speed for the reason that the object to be driven has a small mass or that a physical phenomenon having a fast response speed is used.

This leads to an advantage that it is possible to detect a higher-speed phenomenon in an observation object (for example, living tissue specimen).

Furthermore, when the spatial light modulating element 64 or 66, such as a transmissive or reflective LCOS, is adopted, the function of the phase modulation element 23 can be performed by the spatial light modulating element 64 or 66. By doing so, there is an advantage that it is possible to omit the phase modulation element 23 serving as a wavefront disturbing element, thus further simplifying the configuration.

Furthermore, in the above-described example, the phase modulation element 23 can be omitted in the combination of the spatial light modulating element and the laser-scanning multiphoton excitation observation device; however, similarly to this, the phase modulation element 23 can also be omitted in the combination of the spatial light modulating element and the laser-scanning confocal observation device. Specifically, in FIGS. 17 and 18, the mirror 49 is adopted instead of the beam splitter 36, the dichroic mirror 46 is adopted between the beam expander 45 and the spatial light modulating element 64 or 66, thus forming a split light path, and the imaging lens 24, the confocal pinhole 43, and the photodetector 44 are adopted, thereby making it possible to make the spatial light modulating element 64 or 66 perform the function of the phase modulation element 23. The spatial light modulating element 64 or 66 of this case acts as a wavefront disturbing element, with respect to laser light from the laser light source 41, to give a disturbance to the wavefront thereof and, meanwhile, acts as a wavefront restoring element, with respect to fluorescence from the observation object A, to cancel out a wavefront disturbance given by the phase modulation element 17.

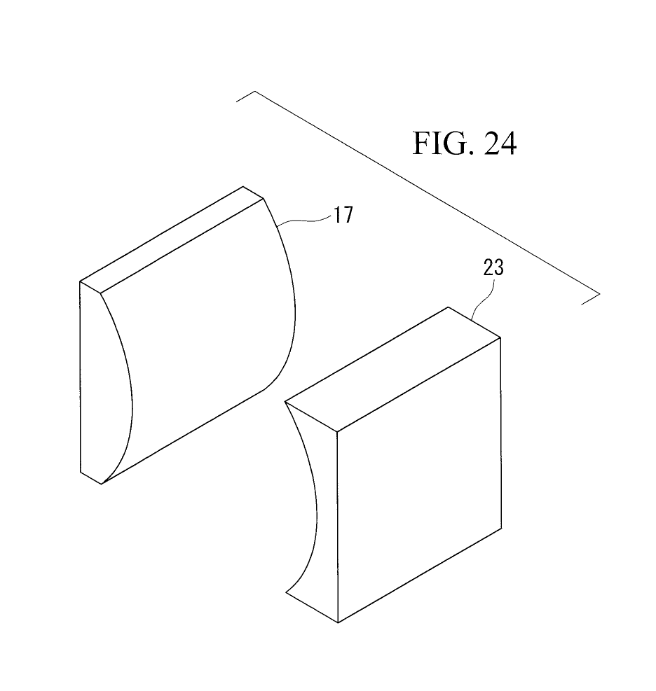

As the phase modulation elements, for example, it is possible to adopt cylindrical lenses 17 and 23 shown in FIG. 24.

In this case, the cylindrical lens 17 linearly extends a point image in an intermediate image due to astigmatism, thus making it possible to blur the intermediate image through this action, and the cylindrical lens 23, which has a shape complementary thereto, can make a final image clear.

In the example of FIG. 24, any of the convex lens and the concave lens can be used as a wavefront disturbing element or can be used as a wavefront restoring element.

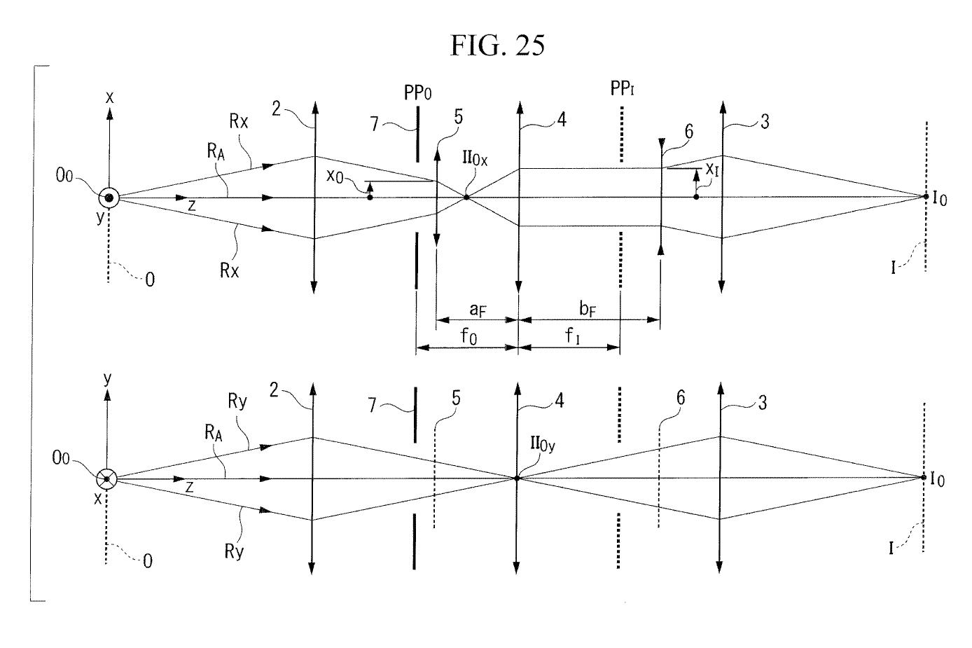

The operation of a case in which cylindrical lenses 5 and 6 are used as phase modulation elements will be described below in detail. FIG. 25 shows an example case in which the cylindrical lenses 5 and 6 are used as the phase modulation elements shown in FIGS. 2 and 3.

Here, in particular, the following conditions are set.

(a) A cylindrical lens that has power ψOₓ in the x-direction is used as the phase modulation element (wavefront disturbing element) 5, which is close to the object O.

(b) A cylindrical lens that has power ψIₓ in the x-direction is used as the phase modulation element (wavefront restoring element) 6, which is close to the image I.

(c) The position (ray height) of an on-axis light ray R_{X} at the cylindrical lens 5 in an xz plane is x_{O}.

(d) The position (ray height) of an on-axis light ray R_{X} at the cylindrical lens 6 in the xz plane is x_{I}.

In FIG. 25, reference signs II_{OX} and II_{OY} denote intermediate images.

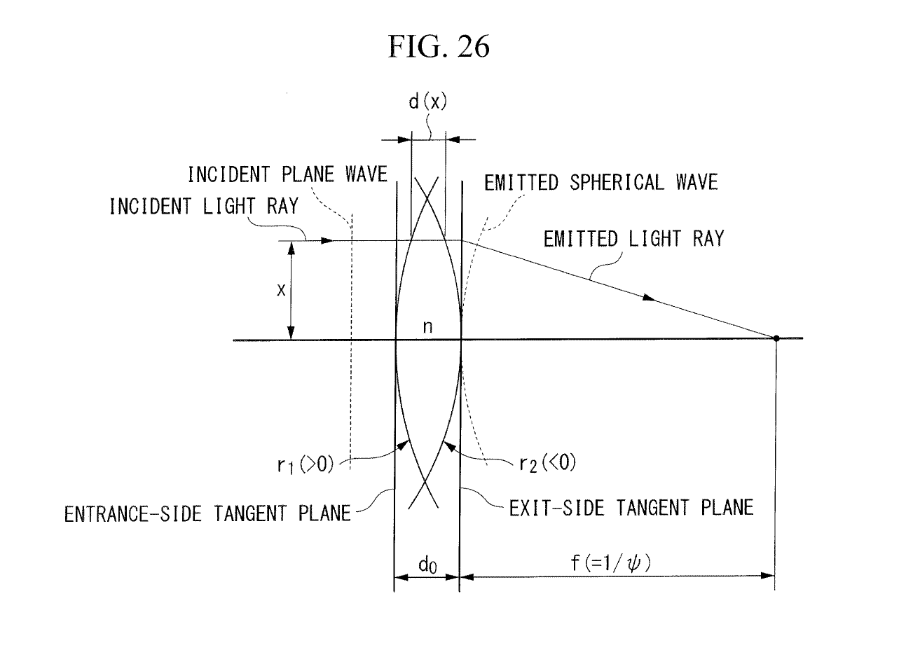

Before describing the operation of this example case, the relationship between the phase modulation amount and the optical power, based on Gaussian optics, will be described with reference to FIG. 26.

In FIG. 26, when the thickness of the lens at a height (the distance from the optical axis) x is d(x), and the thickness of the lens at a height 0 (on the optical axis) is d₀, the optical-path length L(x) from an entrance-side tangent plane to an exit-side tangent plane along a light ray at the height x is expressed by Expression (4).

L(x)=(d₀−d(x))+n·d(x) (4)

When the thin lens approximation is used, the difference between the optical-path length L(x) at the height x and the optical-path length L(0) at the height 0 (on the optical axis) is expressed by Expression (5).

L(x)−L(0)=(−x²/2)(n−1)(1/r₁−1/r₂) (5)

The above-described optical-path-length difference L(x)−L(0) is equal in absolute value to the phase lead of emitted light at the height x with respect to emitted light at the height 0, and they have opposite signs. Therefore, the above-described phase lead is expressed by Expression (6), in which the sign in Expression (5) is reversed.

L(0)−L(x)=(x²/2)(n−1)(1/r₁−1/r₂) (6)

On the other hand, the optical power ψ of this thin lens is expressed by Expression (7).

ψ=1/f=(n−1)(1/r₁−1/r₂) (7)

Therefore, from Expressions (6) and (7), the relationship between the phase lead L(0)−L(x) and the optical power ψ is obtained by Expression (8).

L(0)−L(x)=ψ·x²/2 (8)

Here, FIG. 25 will be described again.

The phase lead ΔL_{Oc} given to the on-axis light ray R_{X} in the xz plane at the cylindrical lens 5 with respect to an on-axis chief ray, i.e., a light ray R_{A} along the optical axis, is expressed by Expression (9) on the basis of Expression (8).

ΔL_{Oc}(x_{O})=L_{Oc}(0)−L_{Oc}(x_{O})=ψ_{Ox}·x_{O}²/2 (9)

Here, L_{Oc}(x_{O}) is a function of the optical-path length from the entrance-side tangent plane to the exit-side tangent plane along the light ray at the height x_{O} in the cylindrical lens 5.

In the same way, the phase lead ΔL_{Ic} given to the on-axis light ray R_{X} in the xz plane at the cylindrical lens 6 with respect to the on-axis chief ray, i.e., the light ray R_{A} along the optical axis, is expressed by Expression (10).

ΔL_{Ic}(x_{I})=L_{Ic}(0)−L_{Ic}(x_{I})=ψ_{Ix}·x_{I}²/2 (10)

Here, L_{Ic}(x_{I}) is a function of the optical-path length from the entrance-side tangent plane to the exit-side tangent plane along the light ray at the height x_{I} in the cylindrical lens 6.

When Expressions (9) and (10) and the relationship (x_{I}/x_{O})2=β_{F}² are applied to Expression (2), in this example, a condition for allowing the cylindrical lens 5 to perform the function of wavefront disturbing and the cylindrical lens 6 to perform the function of wavefront restoration is obtained as shown in Expression (11).

ψ_{Ox}/ψ_{Ix}=−β_{F}² (11)

Specifically, the values ψ_{Ox} and ψ_{Ix} have opposite signs, and the ratio of the absolute values thereof needs to be proportional to the square of the lateral magnification of the field lens 4.

Note that although a description has been given here on the basis of the on-axis light ray, so long as the above-described condition is satisfied, the cylindrical lenses 5 and 6 perform the function of wavefront disturbing and the function of wavefront restoration with respect to an off-axis light ray, as well.

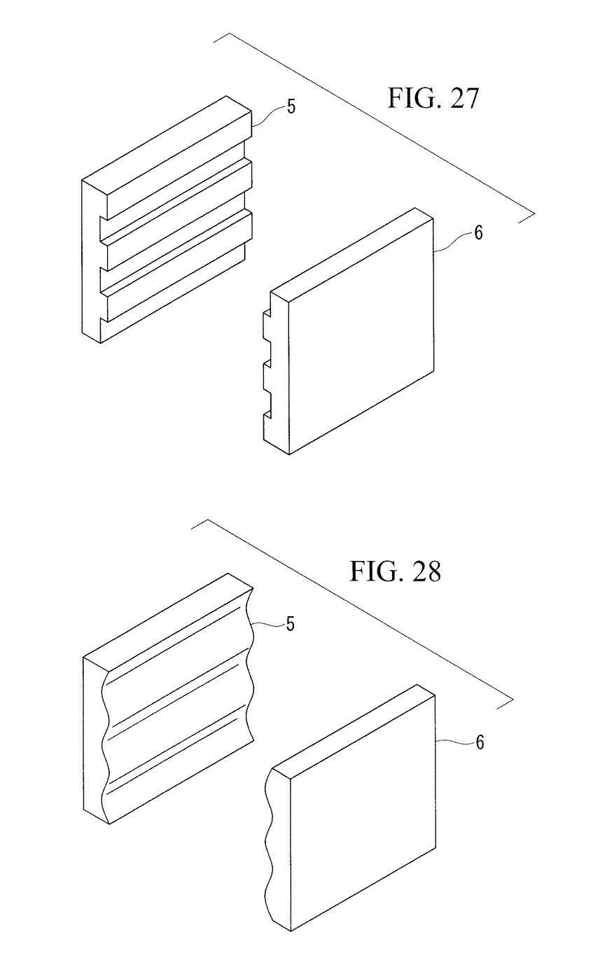

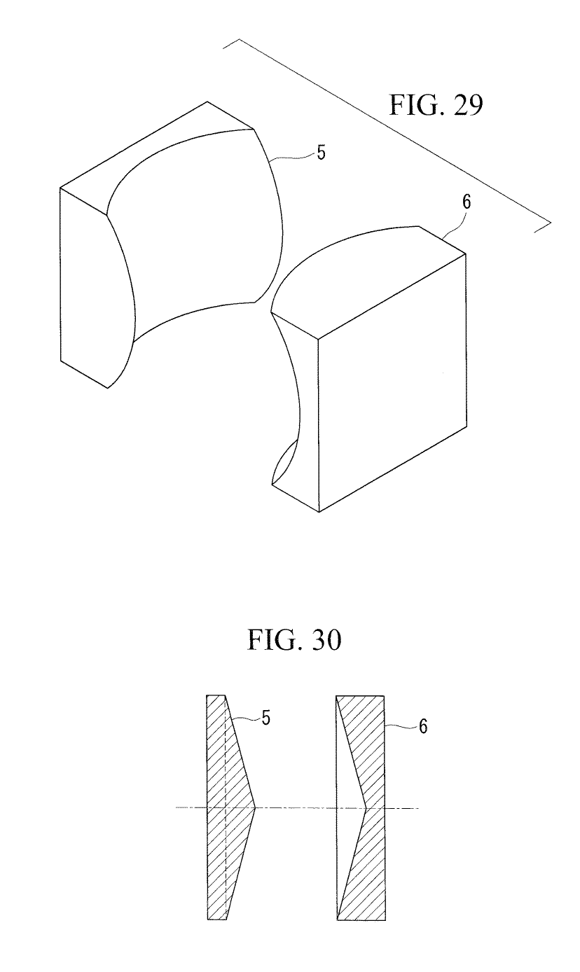

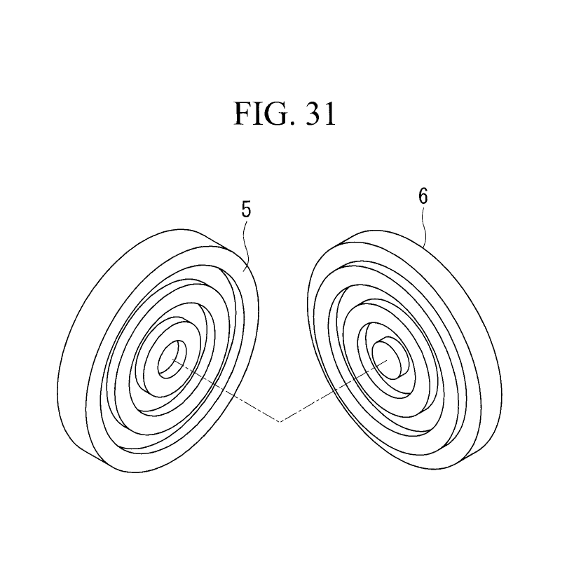

Furthermore, as the phase modulation elements 5, 6, 17, and 23 (shown as the phase modulation elements 5 and 6 in the figure), instead of the cylindrical lenses, it is also possible to adopt one-dimensional binary diffraction gratings as shown in FIG. 27, one-dimensional sinusoidal diffraction gratings as shown in FIG. 28, free-form surface lenses as shown in FIG. 29, cone lenses as shown in FIG. 30, or concentric binary diffraction gratings as shown in FIG. 31. The concentric diffraction gratings are not limited to those of a binary type, and any types of gratings, such as a blazed type and a sinusoidal type, can be adopted.

Here, a case in which diffraction gratings 5 and 6 are used as the wavefront modulation elements will be described below in detail.

In an intermediate image II in this case, a single point image is separated into a plurality of point images due to diffraction.

Through this action, the intermediate image II is blurred, thus making it possible to prevent an image of a foreign object in the intermediate image plane from being overlaid on and included in the final image.

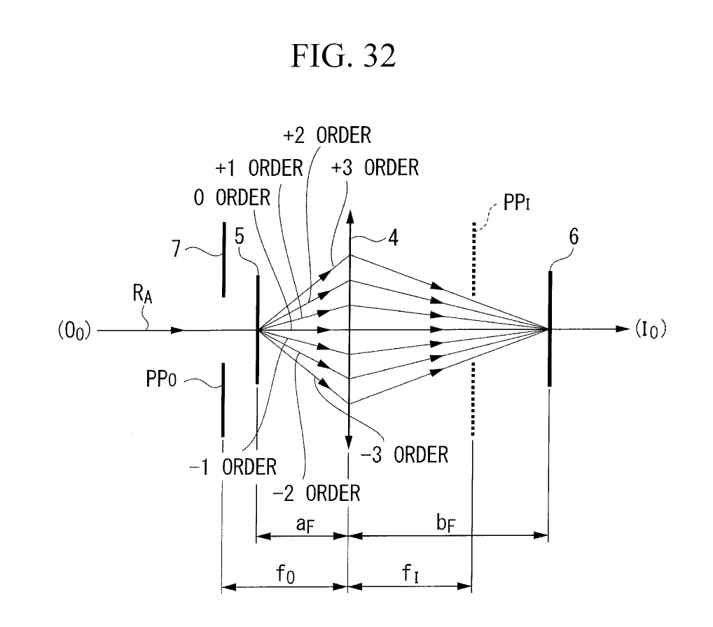

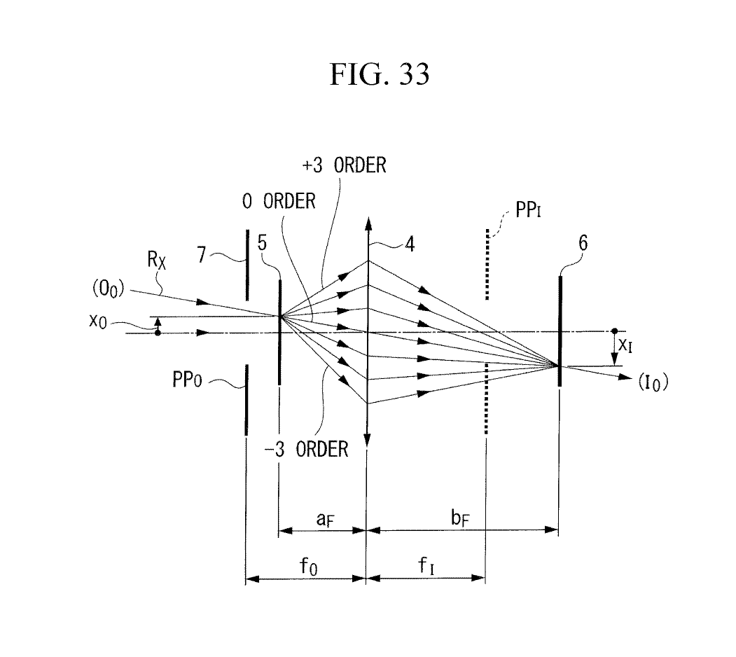

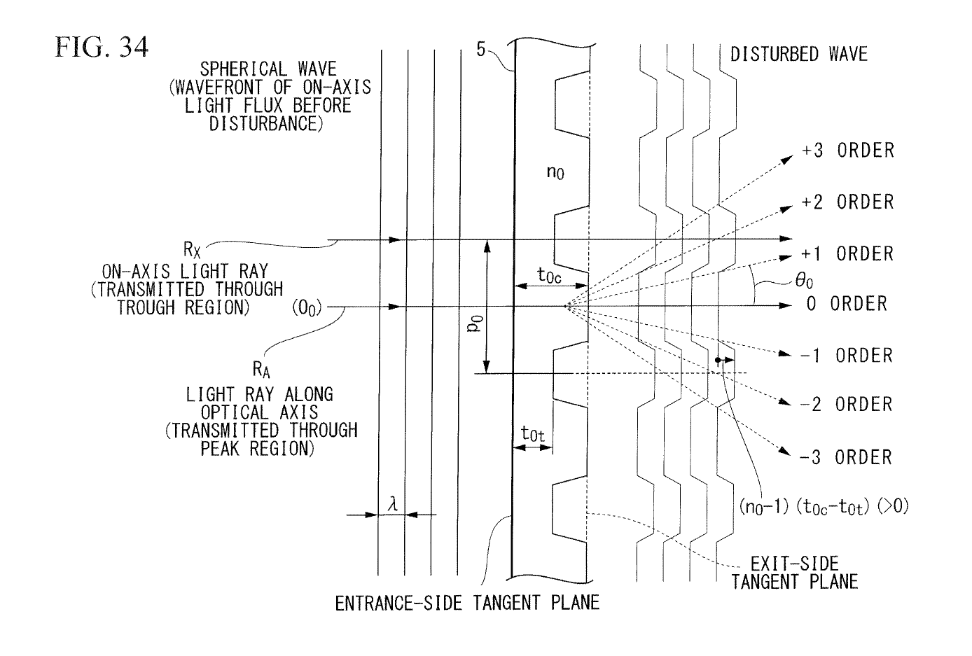

When the diffraction gratings 5 and 6 are used as the phase modulation elements, example preferable paths of an on-axis chief ray, i.e., the light ray R_{A} along the optical axis, are shown in FIG. 32, and example preferable paths of the on-axis light ray R_{X} are shown in FIG. 33. In the figures, each of the light rays R_{A} and R_{X} is separated into a plurality of diffracted light rays when passing through the diffraction grating 5, but the diffracted light rays converge into a single light ray when passing through the diffraction grating 6.

In this case, the above-described effect can be achieved by satisfying Expressions (1) to (3).

Here, according to FIGS. 32 and 33, Expression (2) can be expressed in another way as “the sum of phase modulations to which a single on-axis light ray R_{X} is subjected at the diffraction gratings 5 and 6 is always equal to the sum of phase modulations to which the on-axis chief ray R_{A} is subjected at the diffraction gratings 5 and 6”.

Furthermore, when the diffraction gratings 5 and 6 have periodic structures, if the shapes thereof (i.e., phase modulation characteristics) satisfy Expression (2) in a one-period region, it is possible to consider that they satisfy Expression (2) in the other regions.

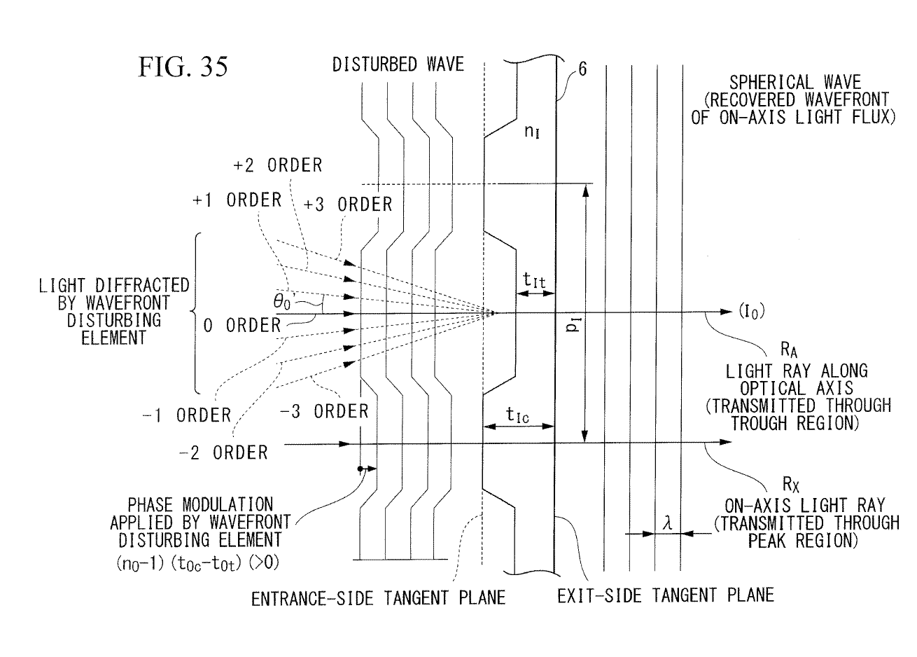

Then, a description will be given of central regions of the diffraction gratings 5 and 6, i.e., regions in the vicinity of the optical axis. FIG. 34 is a view showing details of the central region of the diffraction grating 5, and FIG. 35 is a view showing details of the central region of the diffraction grating 6.

Here, conditions under which the diffraction gratings 5 and 6 satisfy Expression (2) are as follows.

Specifically, a modulation period p_{I} in the diffraction grating 6 needs to be equal to a modulation period p_{O} of the diffraction grating 5 projected by the field lens 4, the phase of modulation of the diffraction grating 6 needs to be inverted with respect to the phase of modulation of the diffraction grating 5 projected by the field lens 4, and the magnitude of phase modulation of the diffraction grating 6 needs to be equal in absolute value to the magnitude of phase modulation of the diffraction grating 5.

First, the condition for making the period p_{I} equal to the projected period p_{O} is expressed by Expression (12).

p_{I}=|β_{F}|·p_{O} (12)

Next, in order to invert the phase of modulation of the diffraction grating 6 with respect to the projected phase of modulation of the diffraction grating 5, it is necessary to satisfy Expression (12), to dispose the diffraction grating 5 such that one of the centers of crest regions thereof coincides with the optical axis, for example, and to dispose the diffraction grating 6 such that one of the centers of trough regions thereof coincides with the optical axis. FIGS. 34 and 35 show just such an example.

Finally, the condition for making the magnitude of phase modulation of the diffraction grating 6 equal in absolute value to the magnitude of phase modulation of the diffraction grating 5 is obtained.

From optical parameters of the diffraction grating 5 (a crest-region thickness t_{Oc}, a trough-region thickness t_{Ot}, and a refractive index n_{O}), the phase lead ΔL_{Odt} that is given to the on-axis light ray R_{X} transmitted through a trough region of the diffraction grating 5, with respect to the light ray R_{A} (transmitted through a crest region) along the optical axis, is expressed by Expression (13).

ΔL_{Odt}=n_{O}·t_{Oc}−(n_{O}·t_{Ot}+(t_{Oc}−t_{Ot}))=(n_{O}−1)(t_{Oc}−t_{Ot}) (13)

In the same way, from optical parameters of the diffraction grating 6 (a crest-region thickness t_{Ic}, a trough-region thickness t_{It}, and a refractive index n_{I}), the phase lead ΔL_{Idt} that is given to the on-axis light ray R_{X} transmitted through a crest region of the diffraction grating 6, with respect to the light ray R_{A} (transmitted through a trough region) along the optical axis, is expressed by Expression (14).

ΔL_{Idt}=(n_{I}·t_{It}+(t_{Ic}−t_{It}))−n_{I}·t_{Ic}=−(n_{I}−1)(t_{Ic}−t_{It}) (14)

In this case, because the value of ΔL_{Odt} is positive, and the value of ΔL_{Idt} is negative, a condition for making the absolute values of them equal is expressed by Expression (15).

ΔL_{Odt}+ΔL_{Idt}=(n_{O}−1)(t_{OC}−t_{Ot})−(n_{Ot}−1)(t_{Ic}−t_{It})=0 (15)

Note that although a description has been given here on the basis of the on-axis light ray, so long as the above-described conditions are satisfied, the diffraction grating 5 performs the function of wavefront disturbance, and the diffraction grating 6 performs the function of wavefront restoration, with respect to an off-axis light ray, as well.

Furthermore, although a description has been given here of an example case in which the diffraction gratings 5 and 6 are trapezoidal in cross section, it is needless to say that the same functions can be performed with another shape.

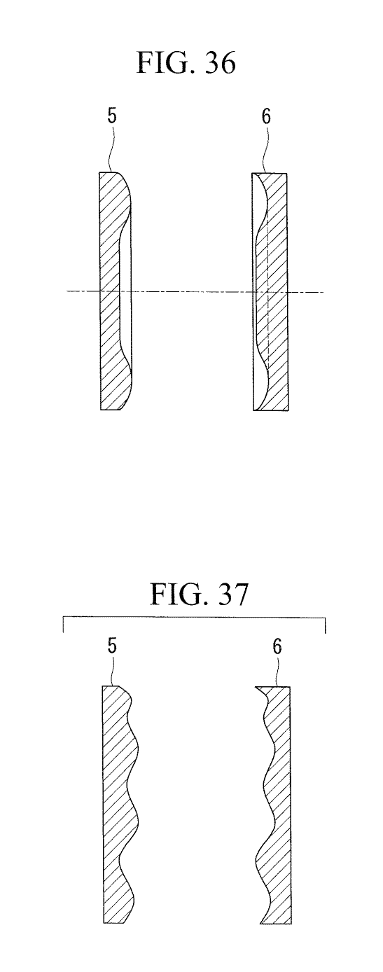

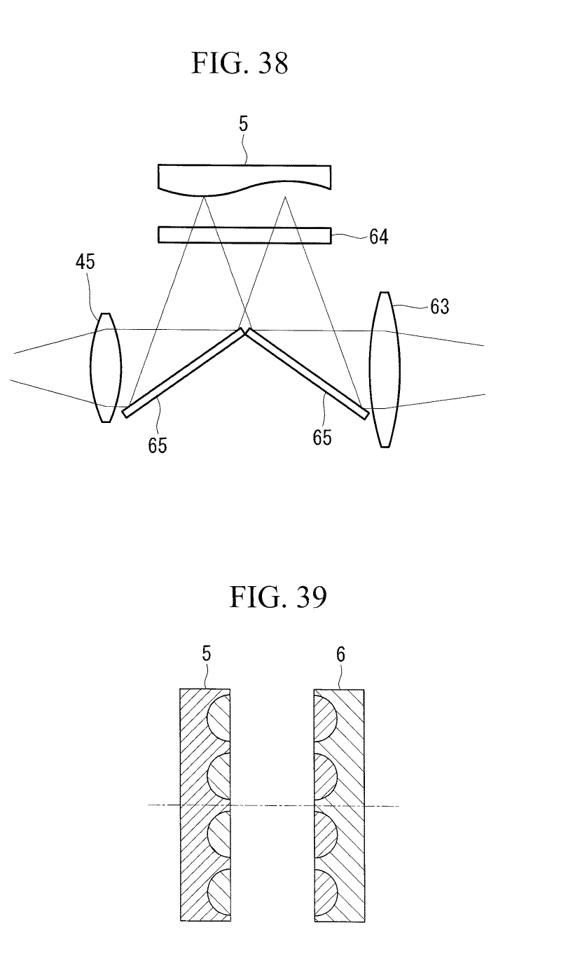

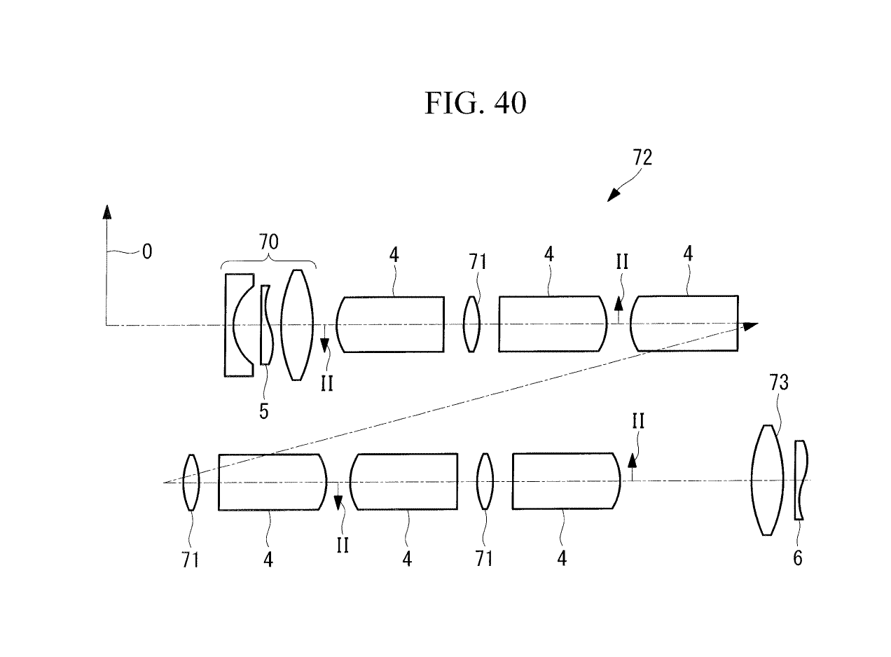

Furthermore, as the phase modulation elements 5 and 6, it is possible to adopt spherical aberration elements, as shown in FIG. 36, irregular-shaped elements, as shown in FIG. 37, a reflective wavefront modulation element used in combination with the transmissive spatial light modulating element 64, as shown in FIG. 38, or refractive-index distribution elements, as shown in FIG. 39.

Furthermore, as the phase modulation elements 5 and 6, it is also possible to adopt fly-eye lenses or microlens arrays in each of which a number of microlenses are arrayed, or microprism arrays in which a number of microprisms are arrayed.

Furthermore, when the imaging optical system 1 of the above-described embodiment is applied to an endoscope, as shown in FIG. 40, a phase disturbing element 5 is disposed in an objective lens (imaging lens) 70, and a phase modulation element 6 is disposed in the vicinity of an eyepiece 73 that is disposed on the opposite side of a relay optical system 72 that includes a plurality of field lenses 4 and focusing lenses 71, from the objective lens 70. By doing so, it is possible to blur intermediate images formed in the vicinities of the surfaces of the field lenses 4 and to make a final image formed by the eyepiece 73 clear.

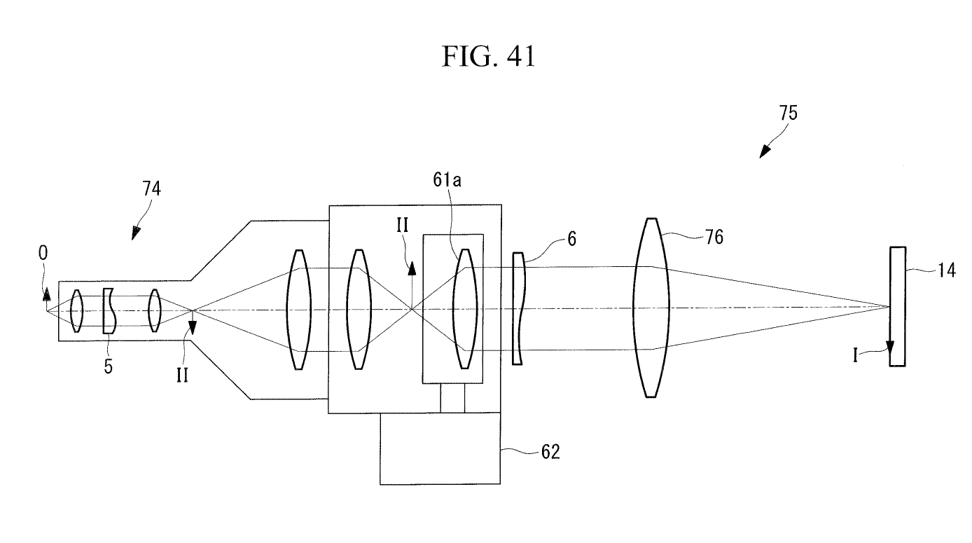

Furthermore, as shown in FIG. 41, it is also possible to provide the wavefront disturbing element 5 in an endoscope-type small-diameter objective lens 74 with an inner focus function, in which a lens 61a is driven by an actuator 62, and to dispose the wavefront restoring element 6 in the vicinity of the pupil position of a tube lens (imaging lens) 76 provided in a microscope body 75. In this way, the actuator itself may be a known lens driving means (for example, a piezoelectric element); however, in terms of movement of an intermediate image on the Z axis, it is important to realize an arrangement for allowing spatial modulation of an intermediate image at the same standpoint as in the above-described embodiments.

In the above-described embodiments, the case in which blurring of an intermediate image through spatial modulation is applied to the imaging optical system of an observation device has been discussed at the standpoint of movement of the intermediate image on the Z axis. Similarly, a case in which blurring of an intermediate image through spatial modulation is applied to an observation device (microscope apparatus) will be discussed below at another standpoint of movement of an intermediate image on XY axes (or in an XY plane). Therefore, the present invention encompasses an imaging optical system, an illuminating device, and an observation device (microscope apparatus) that includes the imaging optical system that are capable of effectively reducing aberrations that could be caused during not only light scanning on the Z axis but also light scanning in the XY plane, by providing the above-described wavefront adjusting means. Furthermore, the present invention can be applied to three-dimensional observation performed by combining both movements of an intermediate image on the Z axis and on the XY axes. In the following aspects, movement of an intermediate image on the XY axes will be described in detail. It is also preferable to perform alternative or concurrent execution depending on the case of an intermediate image on the Z axis. Hereinafter, in order to distinguish from a moving means that only executes movement of an intermediate image on the Z axis, a moving means that only executes movement of an intermediate image on the XY axes is referred to as a scanner. In the following explanation of this scanner, when a plane shape on the XY axes can be changed in the Z-axis direction through part of the movement or throughout the movement of an intermediate image on the XY axes, a solution to a problem at the standpoint of movement of an intermediate image on the Z axis is encompassed.

According to one aspect, the present invention provides an observation device that is provided with: an imaging optical system including a plurality of imaging lenses that form a final image and at least one intermediate image, a first phase modulation element that is disposed closer to an object than any of the at least one intermediate image formed by the imaging lenses is and that gives a spatial disturbance to the wavefront of light from the object, and a second phase modulation element that is disposed at a position so as to sandwich the at least one intermediate image with the first phase modulation element and that cancels out the spatial disturbance given to the wavefront of the light from the object by the first phase modulation element; a light source that is disposed on the object side of the imaging optical system and that produces illumination light to be made to enter the imaging optical system; a first scanner and a second scanner that are provided with a space therebetween in the optical axis direction and that scan the illumination light from the light source; and a photodetector that detects light produced in an observation object disposed at a final image position of the imaging optical system, wherein the first phase modulation element and the second phase modulation element are disposed at positions optically conjugate with the first scanner, which is located on the light source side, and have one-dimensional phase distribution characteristics that change in a direction coincident with the scanning direction of the illumination light scanned by the first scanner.

According to this aspect, when illumination light produced in the light source enters an imaging lens from the object side, the illumination light is focused by the imaging lens, thus being formed into a final image. During this process, when the illumination light passes through the first phase modulation element, which is disposed closer to the object than one intermediate image is, a spatial disturbance is given to the wavefront of the illumination light, and thus, an intermediate image to be formed is blurred and is made unclear. Furthermore, when the illumination light that has been formed into the intermediate image passes through the second phase modulation element, the spatial wavefront disturbance given by the first phase modulation element is cancelled out. Accordingly, a clear image can be acquired when a final image is formed at a stage subsequent to the second phase modulation element.

Specifically, because the intermediate image is blurred and is made unclear, even when the intermediate image is located in the vicinity of an optical element that has a scratch or a foreign object on the surface thereof or a defect therein, it is possible to prevent the occurrence of a disadvantage in that this scratch, foreign object, or defect is overlaid on the intermediate image and is eventually formed as part of the final image.

Furthermore, illumination light from the light source is two-dimensionally scanned by the first scanner and the second scanner, thereby making it possible to two-dimensionally scan a final image formed on the observation object. In this case, when the first scanner is actuated, the light flux of the illumination light is moved in a one-dimensional linear direction; however, because the first scanner and the second phase modulation element are disposed at the optically conjugate positions, the position of the light flux when passing through the second phase modulation element is not fluctuated.

On the other hand, the second scanner, which is provided with a space with respect to the first scanner in the optical axis direction, is not disposed so as to have the optically-conjugate positional relation with the second phase modulation element; therefore, when the second scanner is actuated, the light flux of the illumination light moves so as to change the passing position thereof at which it passes through the second phase modulation element. Because the direction in which the phase distribution characteristics of the second phase modulation element change is coincident with the scanning direction of illumination light scanned by the first scanner, the phase distribution characteristics do not change in a direction perpendicular thereto, i.e., the scanning direction of illumination scanned by the second scanner, and thus, even when the passing position of the light flux of illumination light is changed, the phase modulation applied to the illumination light does not change.

Therefore, according to this aspect, even when either of the first scanner and the second scanner, which are provided with a space therebetween in the optical axis direction, is actuated, it is possible to maintain a constant state without being affected by the scanning state of illumination light and without changing the phase modulation applied by the second phase modulation element, and to completely cancel out the spatial wavefront disturbance given by the first phase modulation element.

In the above-described aspect, the first phase modulation element and the second phase modulation element may be lenticular elements. Furthermore, in the above-described aspect, the first phase modulation element and the second phase modulation element may be prism arrays.

Furthermore, in the above-described aspect, the first phase modulation element and the second phase modulation element may be diffraction gratings. Furthermore, in the above-described aspect, the first phase modulation element and the second phase modulation element may be cylindrical lenses.

Furthermore, according to another aspect, the present invention provides a final-image sharpening method used in an observation device that is provided with: an imaging optical system including a plurality of imaging lenses that form a final image and at least one intermediate image; a light source that is provided on the object side of the imaging optical system and that produces illumination light to be made to enter the imaging optical system; a first scanner and a second scanner that are provided with a space therebetween in the optical axis direction and that scan the illumination light from the light source; and a photodetector that is disposed at a final image position of the imaging optical system and that detects light produced in an observation object, the final-image sharpening method including: disposing a first phase modulation element that gives a spatial disturbance to the wavefront of the illumination light from the light source, at a position optically conjugate with the first scanner, the position being closer to the object than any of the at least one intermediate image formed by the imaging lenses is; and disposing a second phase modulation element that has one-dimensional phase distribution characteristics that change in a direction coincident with the scanning direction of the illumination light scanned by the first scanner and that cancels out the spatial disturbance given to the wavefront of light from the object by the first phase modulation element, at a position that is optically conjugate with the first scanner and that allows the at least one intermediate image to be sandwiched with the first phase modulation element.

According to the aspect of the present invention, an advantageous effect is afforded in that, in the movement of an intermediate image on the XY axes, even when the intermediate image is formed at a position coincident with the position of an optical element, it is possible to acquire a clear final image by preventing a scratch, a foreign object, a defect, etc. on the optical element from being overlaid on the intermediate image.

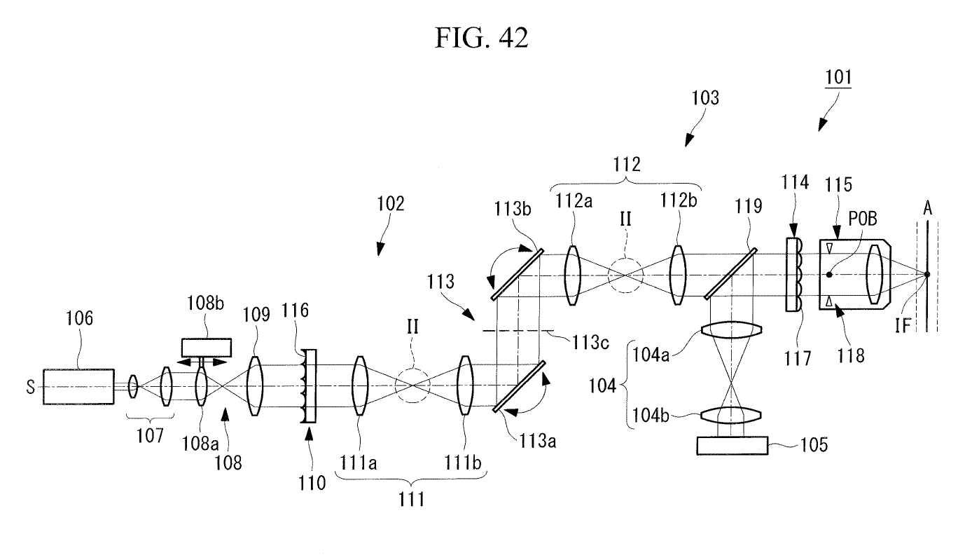

An observation device 101 and a final-image sharpening method according to one embodiment of the present invention will be described below with reference to the drawings. The observation device 101 of this embodiment is, for example, a multiphoton excitation microscopy. As shown in FIG. 42, the observation device 101 is provided with: an illuminating device 102 that radiates extremely-short pulse laser light (hereinafter, simply referred to as laser light (illumination light)) onto the observation object A; a detector optical system 104 that guides, to a photodetector 105, fluorescence produced in the observation object A irradiated with the laser light by the illuminating device 102; and the photodetector 105 that detects the fluorescence guided by the detector optical system 104.

The illuminating device 102 is provided with: a light source 106 that produces laser light; and an imaging optical system 103 that radiates the laser light from the light source 106 onto the observation object A. The imaging optical system 103 is provided with: a beam expander 107 that expands the beam diameter of the laser light from the light source 106; a Z-scanning unit 108 that focuses the laser light that has passed through the beam expander 107 to form an intermediate image and that moves the imaging position in the direction along an optical axis S; and a collimating lens 109 that substantially collimates the laser light that has passed through the Z-scanning unit 108 and that has been formed into the intermediate image.

Furthermore, the imaging optical system 103 is provided with: a wavefront disturbing element (first phase modulation element) 110 that is disposed at a position at which the laser light substantially collimated by the collimating lens 109 is made to pass; a plurality of relay lens pairs (imaging lenses) 111 and 112 that relay an intermediate image formed by the Z-scanning unit 108; an XY scanning unit 113 that is disposed between the relay lens pairs 111 and 112 and that is composed of a galvanometer mirror (first scanner) 113a on the light source 106 side and a galvanometer mirror (second scanner) 113b on the observation object A side; a wavefront restoring element (second phase modulation element) 114 that is disposed at a position at which the laser light that is substantially collimated after passing through the relay lens pairs 111 and 112 is made to pass; and an objective lens (imaging lens) 115 that focuses the laser light that has passed through the wavefront restoring element 114 to radiate the laser light onto the observation object A and that also focuses fluorescence produced at a laser-light focal point (final image I_{F}) in the observation object A.

The Z-scanning unit 108 is provided with: a focusing lens 108a that focuses the laser light whose beam diameter has been expanded by the beam expander 107; and an actuator 108b that moves the focusing lens 108a in the direction along the optical axis S. The actuator 108b moves the focusing lens 108a in the direction along the optical axis S, thereby making it possible to move the imaging position in the direction along the optical axis S.

The wavefront disturbing element 110 is a lenticular element that is formed of an optically transparent material through which light can be transmitted. When laser light is transmitted through the wavefront disturbing element 110, the wavefront disturbing element 110 gives, to the wavefront of the laser light, a phase modulation that changes in a one-dimensional direction perpendicular to the optical axis S, according to the shape of a surface 116 thereof. In this embodiment, when laser light from the light source 106 is transmitted therethrough once, a required wavefront disturbance is given thereto.

In the relay lens pair 111, the laser light that has been substantially collimated by the collimating lens 109 is focused and formed into the intermediate image II by a lens 111a, and then, dispersed laser light is again focused and is substantially collimated by a lens 111b. In this embodiment, the two relay lens pairs 111 and 112 are provided with a space therebetween so as to sandwich the XY scanning unit 113 in the direction along the optical axis S.

The galvanometer mirrors 113a and 113b are provided so as to be able to swivel about axes that are perpendicular to the optical axis S and that have a twisted positional relation. When the galvanometer mirrors 113a and 113b are made to swivel, it is possible to change the inclination angle of the laser light in two-dimensional directions perpendicular to the optical axis S and to scan the position of the final image I_{F} formed by the objective lens 115 in two-dimensional directions intersecting the optical axis S.

The wavefront restoring element 114 is a lenticular element that is formed of an optically transparent material through which light can be transmitted and that has reverse phase distribution characteristics from the wavefront disturbing element 110. When the laser light is transmitted through the wavefront restoring element 114, the wavefront restoring element 114 applies, to the wavefront of the light, a phase modulation that only changes in a one-dimensional direction perpendicular to the optical axis S, according to the shape of a surface 117 thereof, thus cancelling out the wavefront disturbance given by the wavefront disturbing element 110.

In this embodiment, the two galvanometer mirrors 113a and 113b are provided with a space therebetween in the direction along the optical axis S and are provided such that an intermediate position 113c therebetween is disposed at a position substantially optically conjugate with a pupil position POB of the objective lens 115.

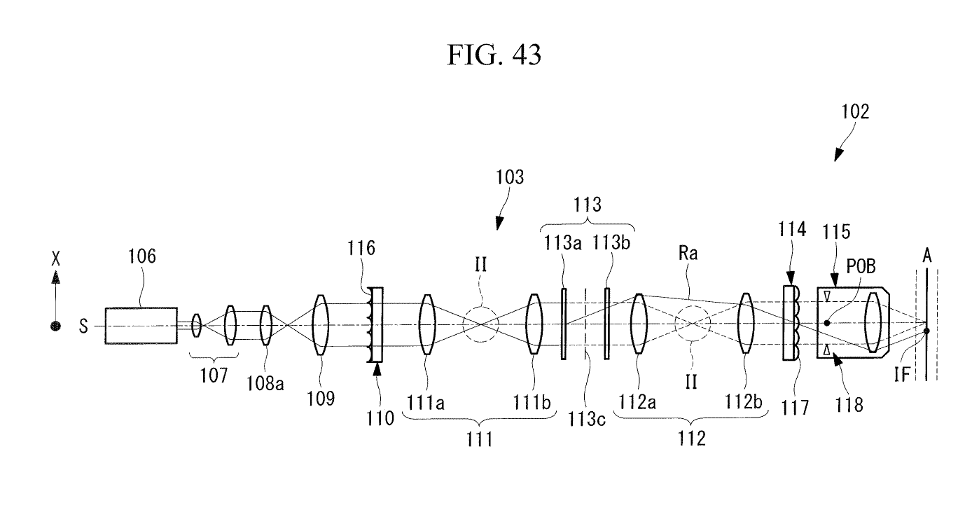

Furthermore, the galvanometer mirror 113a on the light source 106 side is disposed at a position optically conjugate with the wavefront disturbing element 110 and the wavefront restoring element 114. Accordingly, even when the galvanometer mirror 113a on the light source 106 side is made to swivel to give an inclination angle to the laser light, as shown in FIG. 43, a central ray Ra of a light flux P of this laser light intersects the optical axis S at the surface 117 of the wavefront restoring element 114. Specifically, the light flux P of the laser light can be made to pass through the same region without changing the passing position, on the wavefront restoring element 114, at which it passes therethrough.

Then, the galvanometer mirror 113a is provided such that a swivel direction thereof (the direction of an arrow X in FIG. 43) is coincident with the direction in which the phase distribution characteristics of the wavefront restoring element 114 change.

As described above, because the light flux P of the laser light passes through the same region of the wavefront restoring element 114, irrespective of the swivel of the galvanometer mirror 113a, even when the galvanometer mirror 113a swivels, it is not necessary to change the phase modulation to be applied to the laser light.

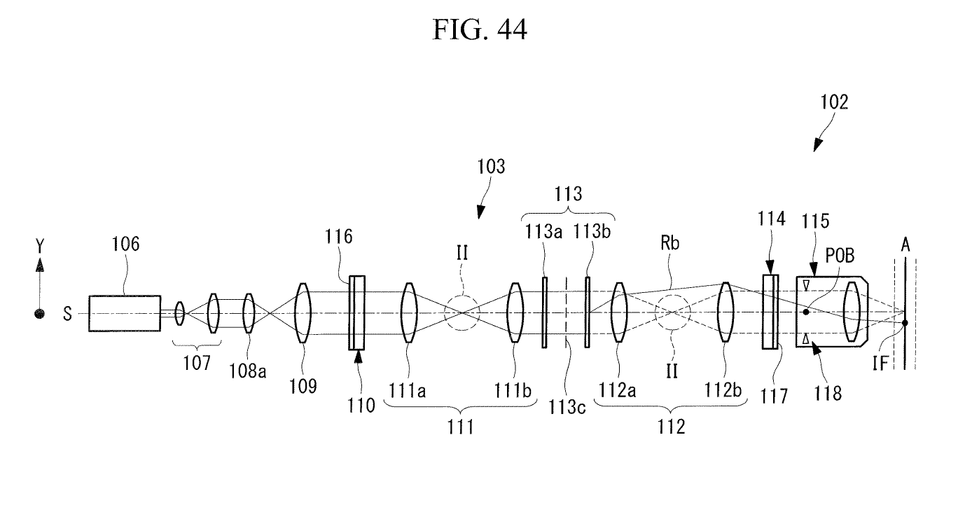

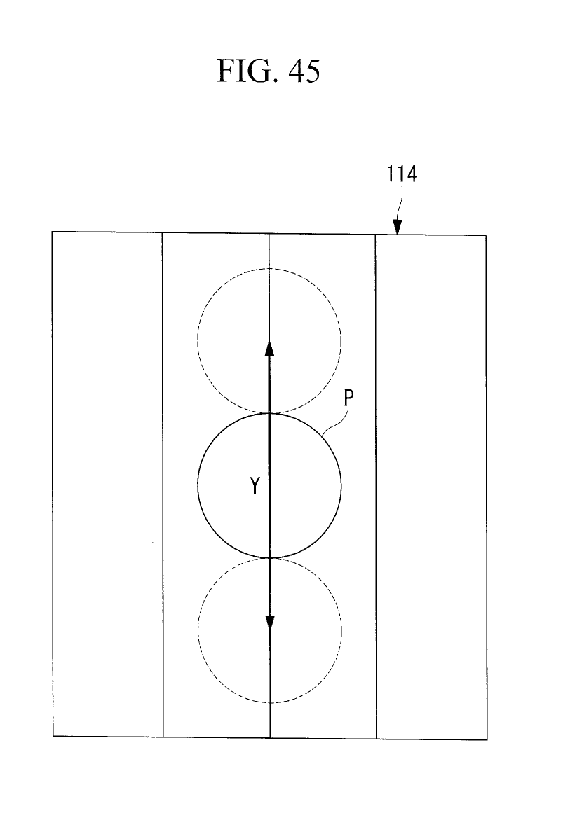

On the other hand, the galvanometer mirror 113b on the observation object A side is disposed at a position optically non-conjugate with the wavefront restoring element 114. Accordingly, when the galvanometer mirror 113b on the observation object A side is made to swivel to give an inclination to the laser light, as shown in FIG. 44, a central ray Rb of the light flux P of the laser light is away from the optical axis S on the surface of the wavefront restoring element 114. Then, the galvanometer mirror 113b is provided such that a swivel direction thereof (the direction of an arrow Y in FIG. 44) is coincident with the direction (direction in which the phase distribution characteristics do not change) perpendicular to the direction in which the phase distribution characteristics of the wavefront restoring element 114 change. Accordingly, when the galvanometer mirror 113b on the observation object A side is made to swivel to give an inclination corresponding to this swivel to the laser light from the galvanometer mirror 113a on the light source 106 side, as shown in FIG. 45, the passing position, on the wavefront restoring element 114, at which the light flux P of the laser light passes is moved, by the inclination given to the laser light, in the direction in which the phase distribution characteristics of the wavefront restoring element 114 do not change.

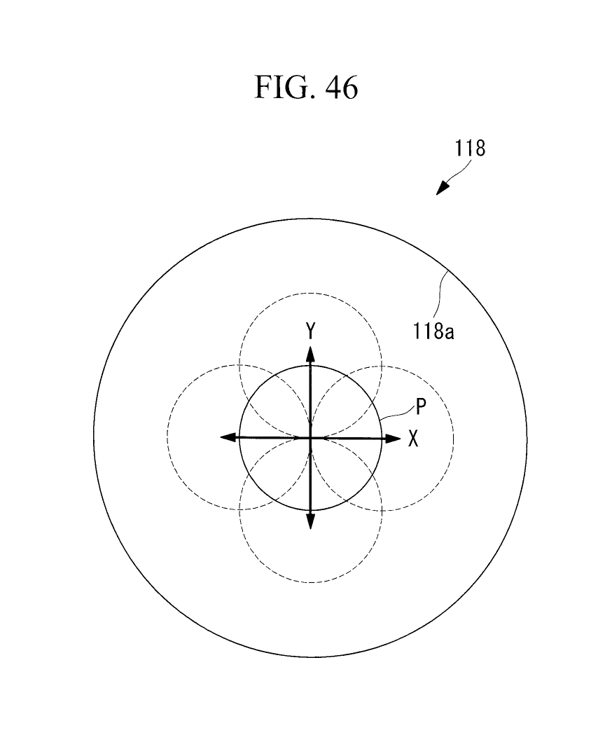

Note that, as described above, the galvanometer mirrors 113a and 113b are both disposed at positions non-conjugate with the pupil position POB of the objective lens 115; therefore, through swivel of the galvanometer mirrors 113a and 113b, the light flux P of the laser light is moved, at the pupil position POB of the objective lens 115, in two-dimensional directions indicated by the arrows X and Y, as shown in FIG. 46. However, the movement range is kept to a minute range for allowing the light flux P of laser light to pass through an aperture 118a of an aperture stop 118 disposed at the pupil position POB of the objective lens 115, without being blocked.

The detector optical system 104 is provided with: a dichroic mirror 119 that splits off fluorescence focused by the objective lens 115 from the light path of the laser light; and two focusing lenses 104a and 104b that focus the fluorescence split off by the dichroic mirror 119. The photodetector 105 is a photomultiplier tube, for example, and detects the intensity of the incident fluorescence.

The operation of the thus-configured observation device 101 of this embodiment will be described below.

In order to observe the observation object A by using the observation device 101 of this embodiment, laser light produced in the light source 106 is radiated onto the observation object A by the imaging optical system 103. The beam diameter of the laser light is first expanded by the beam expander 107, and the laser light is made to pass through the Z-scanning unit 108, the collimating lens 109, and the wavefront disturbing element 110.

The laser light is focused by the focusing lens 108a of the Z-scanning unit 108, and the focus position can be adjusted in the direction along the optical axis S through actuation of the actuator 108b. Furthermore, the laser light is made to pass through the wavefront disturbing element 110, and thus, a spatial disturbance is given to the wavefront thereof.

The laser light is then made to pass through the two relay lens pairs 111 and 112 and the XY scanning unit 113, the inclination angle of the light flux P thereof is changed while being formed into intermediate images II, and the laser light passes through the dichroic mirror 119. Then, the laser light that has passed through the dichroic mirror 119 passes through the wavefront restoring element 114, the spatial disturbance given by the wavefront disturbing element 110 is thus cancelled out, and the laser light is focused by the objective lens 115, thus being formed into the final image I_{F} on the observation object A.

The focal position of the laser light, which is the position of the final image I_{F} formed by the imaging optical system 103, is moved in the direction along the optical axis S by moving the focusing lens 108a through actuation of the actuator 108b. Accordingly, the observation depth of the observation object A can be adjusted. Furthermore, through swivel of the galvanometer mirrors 113a and 113b, the focal position of the laser light in the observation object A can be two-dimensionally scanned in directions perpendicular to the optical axis S.

Even when the laser light to which a spatial wavefront disturbance has been given by the wavefront disturbing element 110 is formed into a plurality of intermediate images II by the relay lens pairs 111 and 112, a single light flux P is divided into a number of small light fluxes, and the small light fluxes are subjected to astigmatism through the operation of a lenticular element, i.e., a cylindrical-lens array, that forms the wavefront disturbing element 110. Accordingly, the originally one point image is blurred and formed as a cluster of a number of circular images, oblong images, or linear images that are arrayed in a straight line. Then, when the laser light passes through the wavefront restoring element 114, the spatial wavefront disturbance given by the wavefront disturbing element 110 is cancelled out; therefore, a clear image can be acquired when a final image I_{F} is formed at a stage subsequent to the wavefront restoring element 114.

Specifically, because the intermediate images II are made to be unclear, thus being blurred, even when the intermediate images II are positioned in the vicinities of optical elements that have a scratch or a foreign object on the surfaces thereof or a defect therein, it is possible to prevent a situation in which the scratch, the foreign object, or the defect is overlaid on the intermediate images II, thus blurring the final image I_{F} formed in the observation object A. As a result, an extremely small spot can be formed as the final image I_{F}.

In this case, even when the galvanometer mirror 113a on the light source 106 side is made to swivel, the light flux P of the laser light is moved in a one-dimensional linear direction; however, the light flux P at the wavefront restoring element 114, which has an optically conjugate positional relation with the galvanometer mirror 113a, passes through the same region thereof in the arrow-X direction. Therefore, irrespective of swivel of the galvanometer mirror 113a, it is not necessary to change the phase modulation to be applied to the laser light by the wavefront restoring element 114.

On the other hand, when the galvanometer mirror 113b on the observation object A side is made to swivel, through this swivel of the galvanometer mirror 113b, the inclination of the light flux P of the laser light is fluctuated, and the passing position on the wavefront restoring element 114 at which the light flux P passes therethrough is moved in the arrow-Y direction. Because the arrow-Y direction is coincident with the direction in which the phase distribution characteristics of the wavefront restoring element 114 do not change, even when the light flux P passes through a different region of the wavefront restoring element 114 in the arrow-Y direction through the movement of the passing position of the light flux P, the phase modulation to be applied does not change. Therefore, even when the galvanometer mirror 113b is made to swivel, it is not necessary to change the phase modulation to be applied to the laser light by the wavefront restoring element 114.

As a result, even when the two galvanometer mirrors 113a and 113b are made to swivel to scan the laser light in two-dimensional directions, the constant phase modulation can always be applied by the wavefront restoring element 114, without being affected by the laser-light scanning state, and the spatial wavefront disturbance given by the wavefront disturbing element 110 can be completely cancelled out.

Then, an extremely small spot is formed in the observation object A, thereby making it possible to increase the photon density in an extremely small region to produce fluorescence. Then, the produced fluorescence is focused by the objective lens 115, is split off by the dichroic mirror 119, and is guided by the detector optical system 104 to the photodetector 105, thus being able to be detected.

The intensities of the fluorescence detected by the photodetector 105 are associated with the three-dimensional laser-light scanning positions, by the positions in the directions of the arrows X and Y scanned by the galvanometer mirrors 113a and 113b and the position in the direction along the optical axis S moved by the actuator 108b, and are stored, thus acquiring a fluorescence image of the observation object A. Specifically, according to the observation device 101 of this embodiment, there is an advantage in that, because fluorescence is produced in an extremely small spot region at each scanning position, a high spatial-resolution fluorescence image can be acquired.

Furthermore, in the observation device 101 of this embodiment, because it is not necessary to dispose a relay-lens pair between the two galvanometer mirrors 113a and 113b, the number of parts in the apparatus can be reduced. Furthermore, a configuration in which the galvanometer mirrors 113a and 113b are disposed close to each other without disposing a relay-lens pair is provided, thereby making it possible to achieve a reduction in the size of the apparatus.

Note that, in this embodiment, lenticular elements are used as examples of the wavefront disturbing element 110 and the wavefront restoring element 114; however, instead of this, it is also possible to adopt elements that have one-dimensional phase distribution characteristics. For example, prism arrays, diffraction gratings, cylindrical lenses, or the like may be adopted.

Furthermore, in this embodiment, the galvanometer mirrors 113a and 113b are used as examples of the first scanner and the second scanner, which are means for moving the intermediate image on the XY axes; however, one or both of them can be replaced with another type of scanner. For example, a polygon mirror, an AOD (acoustic optical deflector), a KTN (Potassium tantalum niobate) crystal, or the like may be adopted.

Furthermore, a multiphoton excitation microscopy is used as an example of the observation device 101 of this embodiment; however, instead of this, the observation device 101 of this embodiment can be applied to a confocal microscope.

According to this, an extremely small spot is formed in the observation object A as a final image I_{F} made clear, thereby making it possible to increase the photon density in an extremely small region to produce fluorescence and to increase the fluorescence passing through the confocal pinhole to acquire a bright confocal image.

Furthermore, as the confocal microscope, instead of detecting fluorescence that passes through the confocal pinhole, it is also possible to detect light that is reflected or scatters at the observation object A and that passes through the confocal pinhole.

Furthermore, in this embodiment, the present invention has been described as the observation device 101; however, the present invention can be regarded as a final-image sharpening method.

Specifically, a final-image sharpening method according to one embodiment of the present invention is a method of sharpening the final image IF in a general laser-scanning multiphoton excitation microscopy that is obtained by removing the wavefront disturbing element 110 and the wavefront restoring element 114 from the observation device 101 shown in FIG. 42.

In the final-image sharpening method of this embodiment, the wavefront disturbing element 110 is disposed at a position between the galvanometer mirror 113a on the light source 106 side and the light source 106, the position being optically conjugate with the galvanometer mirror 113a, and the wavefront restoring element 114 is disposed at a position at the rear of the objective lens 115, the position being optically conjugate with the galvanometer mirror 113a on the light source 106 side. The wavefront restoring element 114 is provided such that the phase distribution characteristics thereof are coincident with the laser-light scanning direction (arrow-X direction) of the galvanometer mirror 113a.

According to this final-image sharpening method, irrespective of the swivel angles of the galvanometer mirrors 113a and 113b, the wavefront restoring element 114 can cancel out the spatial wavefront disturbance given by the wavefront disturbing element 110. Therefore, it is possible to blur the intermediate image II and to prevent an image of a foreign object existing at the imaging position of the intermediate image II from being overlaid on the intermediate image II, thus sharpening the final image I_{F}. Specifically, there is an advantage that, only by adding the wavefront disturbing element 110 and the wavefront restoring element 114 on an existing general scanning multiphoton excitation microscopy, it is possible to sharpen the final image I_{F} and to acquire a high spatial resolution image.

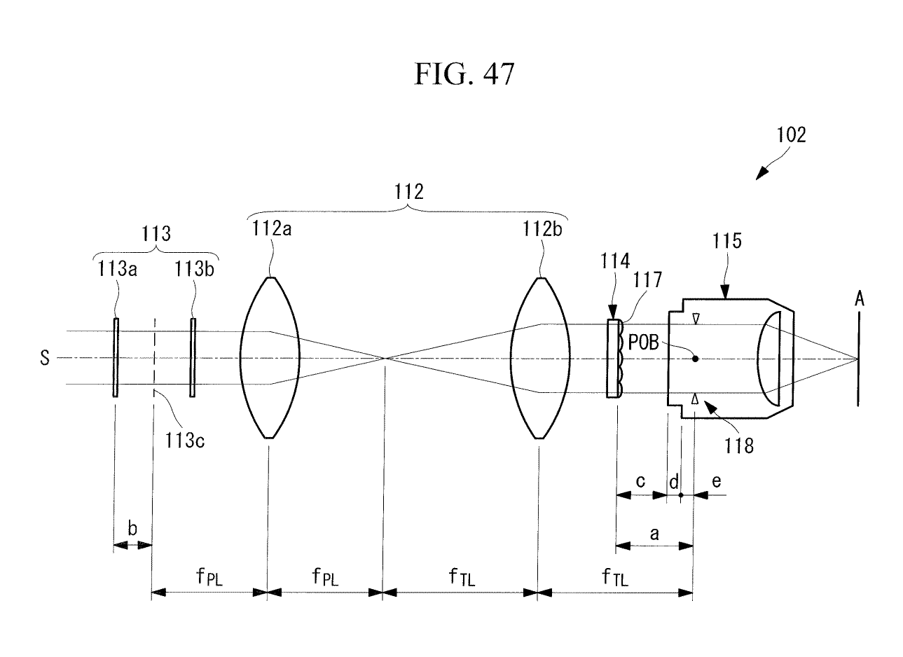

Next, Example of the observation device 101 of this embodiment will be described below with reference to FIG. 47.

The observation device 101 of this embodiment is provided with the illuminating device 102, the detector optical system 104, and the photodetector 105. Furthermore, the distance a from the pupil position POB of the objective lens 115 to the wavefront restoring element 114 satisfies the condition of Expression (16).

a=b(fTL/fPL)2 (16)

Here, b is the distance to the galvanometer mirror 113a located on the light source 106 side from a position 113c that is sandwiched between the two galvanometer mirrors 113a and 113b and that is substantially conjugate with the pupil position POB of the objective lens 115; fPL is the focal length of a lens 112a located on the light source 106 side of a relay-lens pair 112; and fTL is the focal length of a lens 112b located on the observation object A side of the relay-lens pair 112. Furthermore, the distance c from the rear end of a screw of the objective lens 115 to the wavefront restoring element 114 satisfies the condition of Expression (17).

c=a−(d+e) (17)

Here, d denotes the amount of protrusion of the screw of the objective lens 115, and e denotes the distance from an abutment face of the objective lens 115 to the pupil position POB of the objective lens 115.

In this Example, the values are as follows.
b=2.7 (mm)
fPL=52 (mm)
fTL=200 (mm)
d=5 (mm)
e=28 (mm)

Therefore, a=39.9 (mm) is calculated by Expression (16), and c=6.9 (mm) is calculated by Expression (17). As a result, the wavefront restoring element 114 is disposed at a position, at the rear of the objective lens 115, optically conjugate with the galvanometer mirror 113a located on the light source 106 side, without being brought into contact with an outer frame of the objective lens 115.

According to the above-described aspect regarding the movement of an intermediate image on the XY axes, the present invention makes a microscope observation more valuable by combining the above-described aspect regarding the movement of an intermediate image on the XY axes with the above-described aspect regarding the movement of an intermediate image on the Z axis. Therefore, the present invention encompasses the following supplementary information on the basis of the standpoint of blurring of an intermediate image on the XY axes, as exemplified in FIGS. 42 to 47, with respect to the standpoint of blurring of an intermediate image moved on the Z axis, as referred to in FIGS. 1 to 16.

(Supplementary information 1) An observation device that is applied to a Z-axis-scanning type microscope apparatus, the observation device including: an imaging optical system that includes a plurality of imaging lenses that form a final image and at least one intermediate image, a first phase modulation element that is disposed closer to an object than any of the at least one intermediate image formed by the imaging lenses is and that gives a spatial disturbance to the wavefront of light from the object, and a second phase modulation element that is disposed at a position so as to sandwich the at least one intermediate image with the first phase modulation element and that cancels out the spatial disturbance given to the wavefront of the light from the object by the first phase modulation element; a light source that is disposed on the object side of the imaging optical system and that produces illumination light to be made to enter the imaging optical system; a first scanner and a second scanner that are provided with a space therebetween in the optical axis direction and that scan the illumination light from the light source; and a photodetector that detects light produced in an observation object disposed at a final image position of the imaging optical system, wherein the first phase modulation element and the second phase modulation element are disposed at positions optically conjugate with the first scanner, which is located on the light source side, and have one-dimensional phase distribution characteristics that change in a direction coincident with the scanning direction of the illumination light scanned by the first scanner.

(Supplementary information 2) An observation device according to supplementary information 1, wherein the first phase modulation element and the second phase modulation element are lenticular elements.

(Supplementary information 3) An observation device according to supplementary information 1, wherein the first phase modulation element and the second phase modulation element are prism arrays.

(Supplementary information 4) An observation device according to supplementary information 1, wherein the first phase modulation element and the second phase modulation element are diffraction gratings.

(Supplementary information 5) An observation device according to supplementary information 1, wherein the first phase modulation element and the second phase modulation element are cylindrical lenses.

(Supplementary information 6) A final-image sharpening method used in an observation device that is applied together with actuation of a Z-axis-scanning type microscope apparatus and that is provided with: an imaging optical system that includes a plurality of imaging lenses that form a final image and at least one intermediate image; a light source that is disposed on the object side of the imaging optical system and that produces illumination light to be made to enter the imaging optical system; a first scanner and a second scanner that are provided with a space therebetween in the optical axis direction and that scan the illumination light from the light source; and a photodetector that detects light produced in an observation object disposed at a final image position of the imaging optical system, the final-image sharpening method including: disposing a first phase modulation element that gives a spatial disturbance to the wavefront of the illumination light from the light source, at a position optically conjugate with the first scanner, the position being closer to the object than any of the at least one intermediate image formed by the imaging lenses is; and disposing a second phase modulation element that has one-dimensional phase distribution characteristics that change in a direction coincident with the scanning direction of the illumination light scanned by the first scanner and that cancels out the spatial disturbance given to the wavefront of light from the object by the first phase modulation element, at a position that is optically conjugate with the first scanner and that allows the at least one intermediate image to be sandwiched with the first phase modulation element.

Furthermore, according to the above-described supplementary information, the above-described aspect can be summarized as follow.

Specifically, in the above-described supplementary information, it can be said that a technical issue is to acquire a clear final image by preventing, even when an intermediate image is formed at a position coincident with the position of an optical element, a scratch, a foreign object, a defect, etc. on the optical element from being overlaid on the intermediate image. Furthermore, as a solution for solving the technical issue by means of the above-described supplementary information, provided is, as schematically shown in FIG. 42, an observation device 101 that is provided with: an imaging optical system 103 that includes imaging lenses 111, 112, and 115 that form a final image I_{F} and intermediate images II, a first phase modulation element 110 that is disposed closer to an object than any of the intermediate images II is and that gives a spatial disturbance to the wavefront of light, and a second phase modulation element 114 that is disposed closer to the final image I_{F} than at least one of the intermediate images II is and that cancels out the spatial disturbance given to the wavefront of light; a light source 106 that is disposed on the object side; an XY scanning unit 113 that includes first and second scanners 113a and 113b provided with a space therebetween in the direction of the optical axis S; and a photodetector 105 that detects light, wherein the two phase modulation elements 110 and 114 are disposed at positions optically conjugate with the first scanner 113a, which is disposed on the light source 106 side, and that have one-dimensional phase distribution characteristics that change in a direction coincident with the scanning direction of illumination light.

The embodiments of the present invention have been described above in detail with reference to the drawings; however, the specific configurations are not limited to these embodiments, and design changes etc. that do not depart from the gist of the present invention are also encompassed. For example, the present invention is not limited those applied to the above-described embodiments and modifications, can be applied to an embodiment obtained by appropriately combining the embodiments and modifications, and is not particularly limited.

The above-described embodiment leads to the following inventions.

According to one aspect, the present invention provides an imaging optical system including: a plurality of imaging lenses that form a final image and at least one intermediate image; a first phase modulation element that is disposed closer to an object than any of the at least one intermediate image formed by the imaging lenses is and that gives a spatial disturbance to the wavefront of light from the object; and a second phase modulation element that is disposed at a position so as to sandwich the at least one intermediate image with the first phase modulation element and that cancels out the spatial disturbance given to the wavefront of the light from the object by the first phase modulation element, wherein the imaging lenses are configured so as to satisfy Herschel's condition.

In this specification, two concepts, i.e., “clear image” and “unclear image” (or “blurred image”), are used to describe images.

First, a “clear image” means an image that is formed, via an imaging lens, in a state in which a spatial disturbance is not given to the wavefront of light produced in an object or in a state in which a disturbance once given thereto is cancelled out, thus being resolved, and that has a spatial frequency band determined on the basis of the wavelength of light and the numerical aperture of the imaging lens, a spatial frequency band corresponding thereto, or a desired spatial frequency band according to the purpose. Furthermore, an “unclear image” (or “blurred image”) means an image that is formed, via an imaging lens, in a state in which a spatial disturbance is given to the wavefront of light produced in an object and that has such characteristics that a scratch, a foreign object, a defect, or the like that exists on the surface of or in an optical element disposed in the vicinity of that image is not substantially formed as a final image.

In contrast to an image that is merely out of focus, the “unclear image” (or “blurred image”) formed in this way, including an image at a position where it should have been formed (i.e., a position where it should have been formed if a spatial wavefront disturbance would not have been given), does not have a clear image-contrast peak in a wide region in the optical axis direction, and the spatial frequency band thereof is always narrower than the spatial frequency band of a “clear image”.

A “clear image” and an “unclear image” (or “blurred image”) in this specification are based on the above-described concepts, and movement of an intermediate image on the Z axis means that movement of an intermediate image in a blurred state, in the present invention. Furthermore, Z-axis scanning is not limited to only movement of light on the Z axis but may be accompanied with movement of light on the XY axes, to be described later.

According to this aspect, light entering the imaging lenses from object sides thereof is focused by the imaging lenses, thus being formed into a final image. In this case, when the light passes through the first phase modulation element, which is disposed closer to the object than one of the at least one intermediate image is, a spatial disturbance is given to the wavefront of the light, and thus, the formed intermediate image is blurred. Furthermore, when the light formed into the intermediate image passes through the second phase modulation element, the spatial wavefront disturbance given by the first phase modulation element is cancelled out. Accordingly, a clear image can be acquired when a final image is formed at a stage subsequent to the second phase modulation element. In particular, the light passing through the imaging optical system is moved on the Z axis, by the scanning system, while keeping the above-described spatially modulated state in the form of the intermediate image, and the intermediate image while being blurred passes through any lens in the imaging optical system during Z-axis scanning.

Specifically, by blurring the intermediate image, even when any optical element is disposed at the position of the intermediate image, and a scratch, a foreign object, or a defect etc. exists on the surface of or in that optical element, it is possible to prevent a disadvantageous situation in which the scratch or the like is overlaid on the intermediate image and is eventually formed as part of the final image. Furthermore, in a case in which the present invention is applied to a microscope optical system, even when the intermediate image moved on the Z axis through focusing or the like overlaps with a lens that is located nearby, a noise image that eventually includes a scratch or a foreign object on the surface of a lens or a defect etc. in the lens is not formed.

Here, an important idea in the imaging optical system, the illuminating device, and the microscope apparatus of the present invention is provided by configuring the imaging lenses so as to satisfy Herschel's condition. Specifically, by using Herschel's condition, a fluctuation in aberrations caused by Z scanning can be eliminated by the function of first phase modulation element giving a spatial disturbance to the wavefront of light from the object and the function of the second phase modulation element cancelling out the disturbance. Specifically, it is preferred to provide a wavefront adjusting means that has a wavefront adjusting function capable of keeping the Herschel's condition even when the magnification or NA (numerical aperture) is changed through switching between objective lenses. This wavefront adjusting means affords an advantageous effect in that it is possible to suppress a fluctuation in aberrations caused by Z scanning.

On the other hand, in order to perform Z-axis scanning by driving a small lens, it is preferred to use a lens that has a shape so as to reduce the beam diameter and the lens diameter in the Z-axis scanning optical system. Furthermore, it is preferred to provide a wavefront adjusting means that converts a beam in the Z-axis optical system into a beam having a shape that has been subjected to wavefront adjustment so as to suppress a wavefront deformation caused by a reduction in lens diameter, e.g., a Laguerre-Gaussian beam. This wavefront adjusting means affords an advantageous effect in that a reduced lens diameter substantially reduces aberrations, reduces the number of constituent lenses, thus making it possible to reduce the weight, and improves both scanning width and scanning speed.

In the above-described aspect, the first phase modulation element and the second phase modulation element may be disposed at optically conjugate positions.

By doing so, the spatial disturbance given to the wavefront of light from the object by the first phase modulation element is accurately cancelled out by the second phase modulation element, thereby making it possible to form a clear final image.

In the above-described aspect, the first phase modulation element and the second phase modulation element may be disposed in the vicinities of pupil positions of the imaging lenses.

By doing so, it is possible to reduce the sizes of the first phase modulation element and the second phase modulation element by disposing them in the vicinities of the pupil positions, where the light flux is not fluctuated.

In the above-described aspect, it is possible to further include an optical-path-length varying means that can change an optical path length between the two imaging lenses, which are disposed at positions so as to sandwich any of the at least one intermediate image therebetween.

By doing so, the optical path length between the two imaging lenses is changed through actuation of the optical-path-length varying means, thereby making it possible to easily change the imaging position of the final image in the optical axis direction.

Furthermore, in the above-described aspect, the optical-path-length varying means may be provided with: a plane mirror that is disposed perpendicular to the optical axis and that reflects, so as to turn around, light formed into the intermediate image; an actuator that moves the plane mirror in the optical axis direction; and a beam splitter that splits off the light reflected at the plane mirror in two directions.

By doing so, light from the object focused by the imaging lens on the object side is reflected, thus turning around, at the plane mirror, is then split off by the beam splitter, and enters the imaging lens on the image side. In this case, the actuator is actuated to move the plane mirror in the optical axis direction, thereby making it possible to easily change the optical path length between the two imaging lenses and to easily change the imaging position of the final image in the optical axis direction.

Furthermore, in the above-described aspect, it is possible to further include a variable spatial phase modulation element that is disposed in the vicinity of the pupil position of one of the imaging lenses and that changes spatial phase modulation to be applied to the wavefront of light, thereby changing the position of the final image in the optical axis direction.

By doing so, with the variable spatial phase modulation element, it is possible to apply, to the wavefront of light, a spatial phase modulation that changes a final image position in the optical axis direction and to easily change the final image forming position in the optical axis direction by adjusting the phase modulation to be applied.

Furthermore, in the above-described aspect, the function of at least one of the first phase modulation element and the second phase modulation element may be performed by the variable spatial phase modulation element.

By doing so, the variable spatial phase modulation element can be made to perform both: a spatial phase modulation that changes the final image position in the optical axis direction; and a phase modulation that blurs the intermediate image or a phase modulation that cancels out the blurring of the intermediate image. Accordingly, it is possible to reduce the number of components to configure a simple imaging optical system.

Furthermore, in the above-described aspect, the first phase modulation element and the second phase modulation element may apply, to the wavefront of a light flux, phase modulations that change in a one-dimensional direction perpendicular to the optical axis.

By doing so, the first phase modulation element applies, to the wavefront of light, a phase modulation that changes in a one-dimensional direction perpendicular to the optical axis, thus making it possible to blur the intermediate image, and, even when any optical element is disposed at the intermediate image position, and a scratch, a foreign object, or a defect, etc. exists on the surface of or in that optical element, it is possible to prevent a disadvantageous situation in which the scratch or the like is overlaid on the intermediate image and is eventually formed as part of the final image. Furthermore, the second phase modulation element applies, to the wavefront of the light, a phase modulation that cancels out the phase modulation that has changed in the one-dimensional direction, thus making it possible to form a clear, unblurred final image.

Furthermore, in the above-described aspect, the first phase modulation element and the second phase modulation element may apply, to the wavefront of a light flux, phase modulations that change in two-dimensional directions perpendicular to the optical axis.

By doing so, the first phase modulation element applies, to the wavefront of light, a phase modulation that changes in two-dimensional directions perpendicular to the optical axis, thus making it possible to more reliably blur the intermediate image. Furthermore, the second phase modulation element applies, to the wavefront of the light, a phase modulation that cancels out the phase modulation that has changed in the two-dimensional directions, thus making it possible to form a clearer final image.

Furthermore, in the above-described aspect, the first phase modulation element and the second phase modulation element may be transmissive elements that apply phase modulations to the wavefront of light when the light is transmitted therethrough.

Furthermore, in the above-described aspect, the first phase modulation element and the second phase modulation element may be reflective elements that apply phase modulations to the wavefront of light when the light is reflected thereat.

Furthermore, in the above-described aspect, the first phase modulation element and the second phase modulation element may have complementary shapes.

By doing so, it is possible to simply configure the first phase modulation element, which gives a spatial disturbance for blurring an intermediate image to the wavefront, and the second phase modulation element, which applies a phase modulation for canceling out the spatial disturbance given to the wavefront.

Furthermore, in the above-described aspect, the first phase modulation element and the second phase modulation element may apply, to the wavefront, phase modulations through refractive-index distributions of transparent materials.

By doing so, it is possible to make the first phase modulation element cause a wavefront disturbance according to the refractive-index distribution when light is transmitted therethrough and to make the second phase modulation element apply, to the wavefront of the light, a phase modulation that cancels out the wavefront disturbance due to the refractive-index distribution when the light is transmitted therethrough.

Furthermore, according to another aspect, the present invention provides an illuminating device including: one of the above-described imaging optical systems; and a light source that is disposed on the object side of the imaging optical system and that produces illumination light to be made to enter the imaging optical system.

According to this aspect, illumination light produced in the light source, which is disposed on the object side, enters the imaging optical system, thereby making it possible to radiate the illumination light onto an illumination object that is disposed on the final image side. In this case, the first phase modulation element blurs an intermediate image formed by the imaging optical system; therefore, even when any optical element is disposed at the intermediate image position, and a scratch, a foreign object, or a defect, etc. exists on the surface of or in that optical element, it is possible to prevent a disadvantageous situation in which the scratch or the like is overlaid on the intermediate image and is eventually formed as part of the final image.

Furthermore, according to still another aspect of the present invention, it is possible to include: one of the above-described imaging optical systems; and a photodetector that is disposed on the final image side of the imaging optical system and that detects light produced in an observation object.

According to this aspect, it is possible to detect, with the photodetector, a clear final image that is formed, by the imaging optical system, by preventing the image of a scratch or a foreign object on the surface of the optical element or a defect therein from being overlaid on an intermediate image.

In the above-described aspect, the photodetector may be an image acquisition device that is disposed at a position of the final image of the imaging optical system and that acquires the final image.

By doing so, the image acquisition device, which is disposed at the final image position in the imaging optical system, can acquire a clear final image to perform highly accurate observation.

Furthermore, according to still another aspect, the present invention provides a microscope apparatus including: one of the above-described imaging optical systems; a light source that is disposed on the object side of the imaging optical system and that produces illumination light to be made to enter the imaging optical system; and a photodetector that is disposed on the final image side of the imaging optical system and that detects light produced in an observation object.

According to this aspect, light from the light source is focused by the imaging optical system and is radiated onto an observation object, and light produced in the observation object is detected by the photodetector, which is disposed on the final image side. Accordingly, it is possible to detect, with the photodetector, a clear final image that is formed by preventing an image of a scratch or a foreign object on the surface of an intermediate optical element or a defect therein from being overlaid on an intermediate image.

In the above-described aspect, it is possible to further include a Nipokow-disk confocal optical system that is disposed among the light source, the photodetector, and the imaging optical system.

By doing so, it is possible to scan multiple spots of light on the observation object and to rapidly acquire a clear image of the observation object.

Furthermore, in the above-described aspect, the light source may be a laser light source; and the photodetector may be provided with a confocal pinhole and a photoelectric conversion element.

By doing so, it is possible to perform observation of an observation object using a clear confocal image that does not includes a scratch, a foreign object, or a defect existing at the intermediate image position.

Furthermore, according to still another aspect, the present invention provides a microscope apparatus including: the above-described illuminating device; and a photodetector that detects light produced in an observation object irradiated by the illuminating device, wherein the light source is a pulse laser light source.

By doing so, it is possible to perform observation of an observation object using a clear multiphoton excitation image that does not includes a scratch, a foreign object, or a defect existing at the intermediate image position.

In the above-described aspect, it is possible to further include an optical scanner, wherein the optical scanner is disposed at a position optically conjugate with the first phase modulation element, the second phase modulation element, and the pupils of the imaging lenses.

With this configuration, it is possible to cause the optical scanner to scan illumination light on the observation object and to acquire a clear image of a scanning range of the illumination light in the observation object.

### REFERENCE SIGNS LIST

I final image
II intermediate image
O object
PP_{O}, PP_{I} pupil position
1, 13, 32, 42 imaging optical system
2, 3 imaging lens
5 wavefront disturbing element (first phase modulation element)
6 wavefront restoring element (second phase modulation element)
10, 30, 40, 50, 60, 130 observation device (microscope apparatus)
11, 31, 41 light source
14, 33 image acquisition device (photodetector)
17, 23 phase modulation element
20, 36 beam splitter
22 optical-path-length varying means
22a plane mirror
22b actuator
34 Nipkow-disk confocal optical system
43 confocal pinhole
44 photodetector (photoelectric conversion element)
61a lens (optical-path-length varying means)
62 actuator (optical-path-length varying means)
64 spatial light modulating element (variable spatial phase modulation element)
101 observation device
103 imaging optical system
105 photodetector
106 extremely-short pulse laser light (light source)
110 wavefront disturbing element (first phase modulation element)
111, 112 relay-lens pair (imaging lens)
113 XY scanning unit
113a galvanometer mirror (first scanner)
113b galvanometer mirror (second scanner)
114 wavefront restoring element (second phase modulation element)
115 objective lens (imaging lens)

1. An imaging optical system comprising:
a plurality of imaging lenses that form a final image and at least one intermediate image;
a first phase modulation element that is disposed closer to an object than any of the at least one intermediate image formed by the imaging lenses is and that gives a spatial disturbance to a wavefront of light from the object; and
a second phase modulation element that is disposed at a position so as to sandwich the at least one intermediate image with the first phase modulation element and that cancels out the spatial disturbance given to the wavefront of the light from the object by the first phase modulation element,
wherein the imaging lenses are configured so as to satisfy Herschel's condition.

2. An imaging optical system according to claim 1, wherein the first phase modulation element and the second phase modulation element are disposed at optically conjugate positions.

3. An imaging optical system according to claim 1, wherein the first phase modulation element and the second phase modulation element are disposed in the vicinities of pupil positions of the imaging lenses.

4. An imaging optical system according to claim 1, further comprising an optical-path-length varying portion that can change an optical path length between the two imaging lenses, which are disposed at positions so as to sandwich any of the at least one intermediate image therebetween.

5. An imaging optical system according to claim 4, wherein the optical-path-length varying portion is provided with: a plane mirror that is disposed perpendicular to an optical axis and that reflects, so as to turn around, light formed into the intermediate image; an actuator that moves the plane mirror in the optical axis direction; and a beam splitter that splits off the light reflected at the plane mirror in two directions.

6. An imaging optical system according to claim 1, further comprising a variable spatial phase modulation element that is disposed in the vicinity of a pupil position of one of the imaging lenses and that changes spatial phase modulation to be applied to the wavefront of light, thereby changing a position of the final image in the optical axis direction.

7. An imaging optical system according to claim 6, wherein function of at least one of the first phase modulation element and the second phase modulation element is performed by the variable spatial phase modulation element.

8. An imaging optical system according to claim 1, wherein the first phase modulation element and the second phase modulation element apply, to the wavefront of a light flux, phase modulations that change in a one-dimensional direction perpendicular to the optical axis.

9. An imaging optical system according to claim 1, wherein the first phase modulation element and the second phase modulation element apply, to the wavefront of a light flux, phase modulations that change in two-dimensional directions perpendicular to the optical axis.

10. An imaging optical system according to claim 1, wherein the first phase modulation element and the second phase modulation element are transmissive elements that apply phase modulations to the wavefront of light when the light is transmitted therethrough.

11. An imaging optical system according to claim 1, wherein the first phase modulation element and the second phase modulation element are reflective elements that apply phase modulations to the wavefront of light when the light is reflected thereat.

12. An imaging optical system according to claim 1, wherein the first phase modulation element and the second phase modulation element have complementary shapes.

13. An imaging optical system according to claim 10, wherein the first phase modulation element and the second phase modulation element apply, to the wavefront, phase modulations through refractive-index distributions of transparent materials.

14. An illuminating device comprising:
an imaging optical system according to claim 1; and
a light source that is disposed on the object side of the imaging optical system and that produces illumination light to be made to enter the imaging optical system.

15. A microscope apparatus comprising:
an imaging optical system according to claim 1; and
a photodetector that is disposed on the final image side of the imaging optical system and that detects light produced in an observation object.

16. A microscope apparatus according to claim 15, wherein the photodetector is an image acquisition device that is disposed at a position of the final image of the imaging optical system and that acquires the final image.

17. A microscope apparatus comprising:
an imaging optical system according to claim 1;
a light source that is disposed on the object side of the imaging optical system and that produces illumination light to be made to enter the imaging optical system; and
a photodetector that is disposed on the final image side of the imaging optical system and that detects light produced in an observation object.

18. A microscope apparatus according to claim 17, further comprising a Nipokow-disk confocal optical system that is disposed among the light source, the photodetector, and the imaging optical system.

19. A microscope apparatus according to claim 17,
wherein the light source is a laser light source; and
the photodetector is provided with a confocal pinhole and a photoelectric conversion element.

20. A microscope apparatus comprising:
an illuminating device according to claim 14; and
a photodetector that detects light produced in an observation object irradiated by the illuminating device,
wherein the light source is a pulse laser light source.

21. A microscope apparatus according to claim 19, further comprising an optical scanner,
wherein the optical scanner is disposed at a position optically conjugate with the first phase modulation element, the second phase modulation element, and pupils of the imaging lenses.

22. A microscope apparatus according to claim 20, further comprising an optical scanner,
wherein the optical scanner is disposed at a position optically conjugate with the first phase modulation element, the second phase modulation element, and pupils of the imaging lenses.
